(19) United States
(12) Patent Application Publication
(10) Pub. No.: US 2023/0196541 A1
(43) Pub. Date: Jun. 22, 2023

(54) DEFECT DETECTION USING NEURAL NETWORKS BASED ON BIOLOGICAL CONNECTIVITY

(71) Applicant: X Development LLC, Mountain View, CA (US)

(72) Inventors: Sarah Ann Laszlo, Mountain View, CA (US); Lam Thanh Nguyen, Mountain View, CA (US); Baihan Lin, New York, NY (US)

(21) Appl. No.: 17/559,641

(22) Filed: Dec. 22, 2021

(51) Int. Cl. G06T 7/00; G06N 3/04; G06N 3/00

(52) U.S. Cl. CPC G06T 7/0004; G06N 3/0454; G06N 3/008; G06T 2207/20084; G06T 2207/30108; G06T 2207/20081

(57) ABSTRACT

Methods, systems, and apparatus, including computer programs encoded on a computer storage medium, for performing defect detection using brain emulation neural networks. One of the methods includes obtaining an image of a manufactured article; processing the image of the manufactured article using an encoder subnetwork of a defect detection neural network to generate an encoder subnetwork output; processing the encoder subnetwork output using a brain emulation subnetwork of the defect detection neural network to generate a brain emulation subnetwork output, wherein the brain emulation subnetwork has an architecture that comprises brain emulation parameters that, when initialized, represent biological connectivity between biological neuronal elements in a brain of a biological organism; processing the brain emulation subnetwork output using a decoder subnetwork of the defect detection neural network to generate a network output that predicts whether the manufactured article includes a defect; and taking an action based on the network output.

### BACKGROUND

This specification relates to processing data using machine learning models. Machine learning models receive an input and generate an output, e.g., a predicted output, based on the received input. Some machine learning models are parametric models and generate the output based on the received input and on values of the parameters of the model.

Some machine learning models are deep models that employ multiple layers of computational units to generate an output for a received input. For example, a deep neural network is a deep machine learning model that includes an output layer and one or more hidden layers that each apply a non-linear transformation to a received input to generate an output.

### SUMMARY

This specification describes systems implemented as computer programs on one or more computers in one or more locations for performing defect detection using a neural network that includes a brain emulation subnetwork whose parameters have been determined according to the biological connectivity between neuronal elements in the brain of a biological organism, e.g., a fly, a mouse, or a cat. The neural network is configured through training to process sensor data representing one or more manufactured articles, or a network input generated from the sensor data, and to generate a prediction about whether the manufactured articles have a defect. For example, the neural network can be configured to perform semantic segmentation on the sensor data, identifying elements of the sensor data that represent defective components of the manufactured articles.

This specification also describes systems for training a neural network that includes a brain emulation subnetwork to perform defect detection.

The sensor data can be any appropriate type of data that characterizes one or more manufactured articles. For example, the sensor data can be captured by one or more sensors within or proximate to the manufacturing environment in which the articles were manufactured.

In some implementations, the parameters of the brain emulation subnetwork of the neural network can be determined using a synaptic connectivity graph. A synaptic connectivity graph refers to a graph representing the structure of biological connections (e.g., synaptic connections or nerve fibers) between neuronal elements (e.g., neurons, portions of neurons, or groups of neurons) in the brain of a biological organism, e.g., a fly. For example, the synaptic connectivity graph can be generated by processing a synaptic resolution image of the brain of a biological organism.

For convenience, throughout this specification, an artificial neural network layer whose parameters have been determined using biological connectivity is called a “brain emulation” neural network layer. For convenience and to distinguish from brain emulation neural network layers, this specification refers to neural network layers whose parameters have not been determined using biological connectivity as “non-biological” neural network layers. The parameters of a non-biological neural network layer can be determined using supervised learning (e.g., backpropagation and gradient descent), unsupervised learning, or reinforcement learning, to name just a few examples. In some implementations, the parameters of a brain emulation neural network layer of a neural network are also updated during training of the neural network. That is, initial values for the parameters of the brain emulation neural network layer can be determined using biological connectivity, and those initial values can be updated using machine learning techniques.

In this specification, an artificial neural network having at least one brain emulation neural network layer is called a “brain emulation” neural network. Identifying an artificial neural network as a “brain emulation” neural network is intended only to conveniently distinguish such neural networks from other neural networks (e.g., with hand-engineered architectures), and should not be interpreted as limiting the nature of the operations that can be performed by the neural network or otherwise implicitly characterizing the neural network.

Similarly, in this specification, a subnetwork of an artificial neural network that includes at least one brain emulation neural network layer is called a “brain emulation” subnetwork, while other subnetworks of the neural network that do not include any brain emulation neural network layers are called “non-biological” subnetworks.

In this specification, the non-biological neural network layer immediately preceding a brain emulation subnetwork in the architecture of a neural network, and the non-biological neural network layer immediately following the brain emulation subnetwork in the architecture of the neural network, are called “connectivity” neural network layers. In some implementations, for each of one or more connectivity neural network layers of a neural network, the connectivity neural network layer divides the layer input to the connectivity neural network layer into multiple different channels, and processes each channel using one or more sub-layers of the connectivity neural network layer. Each sub-layer of a connectivity neural network layer can process a proper subset of the channels of the layer input to generate a respective channel of the layer output of the connectivity neural network layer.

This process can significantly reduce the number of computations executed by the connectivity neural network layer compared to a fully-connected neural network layer.

In this specification, a “channel” of a first array of values is another array of values that includes a proper subset of the values of the first array. For example, if the first array is an N-dimensional array of values, then a channel of the first array can be an array that has at most N dimensions. In some implementations, a channel of an array includes a contiguous proper subset of the values of the array, i.e., each value in the channel is adjacent, within the array, to at least one other value in the channel.

Particular embodiments of the subject matter described in this specification can be implemented so as to realize one or more of the following advantages.

Using techniques described in this specification, a system can process images of manufactured articles using a brain emulation neural network to predict the presence of defects in the manufactured articles. The system can use the generated predictions to ensure that defective articles are not released, e.g., for sale to consumers. For example, the system can alert a user or an external system when a particular manufactured article is predicted to have a defect, and the particular manufactured article can be removed from the manufacturing pipeline for further inspection, e.g., manual inspection by the user.

Using techniques described in this specification, a system can train a brain emulation neural network to perform defect detection with higher accuracy than some existing techniques. Identifying and removing defective products can improve the safety and reliability of products that are sold to consumers. A failure to identify a defective product can cause serious safety issues, especially in situations in which the product is used in a high-risk environment, e.g., if the product is a component of a vehicle, or if the product is a type of personal protective equipment (PPE), to name just a couple of examples. Thus, the techniques described in this specification can significantly improve health and safety outcomes of customers and the wider public.

In particular, as described in this specification, neural networks that include brain emulation subnetworks can achieve a higher performance (e.g., in terms of prediction accuracy) than other neural networks of an equivalent or greater size (e.g., in terms of number of parameters). In other words, a brain emulation neural network trained to perform defect detection as described in this specification can achieve high performance while being more efficient than some existing neural networks, e.g., by requiring less time and fewer computational and memory resources to generate a prediction.

For example, in some implementations described in this specification, a brain emulation subnetwork of a neural network can have significantly fewer parameters than the non-biological subnetworks of the neural network. For example, a brain emulation subnetwork of a neural network can include 100 or 1000 parameters, while the non-biological subnetworks of the neural network include hundreds of thousands or millions of parameters. Thus, inserting a brain emulation subnetwork into the architecture of a neural network can significantly improve the performance of the neural network while only negligibly increasing the number of computations or the amount of time required to execute the operations performed by the neural network. Therefore, using techniques described in this specification, a system can implement a highly efficient, low-latency, and low-power-consuming neural network.

The efficiency gains of brain emulation neural networks when processing sensor data of manufactured articles can be especially important in situations in which the brain emulation neural network is continuously processing network inputs. For example, the brain emulation neural network can be deployed directly in the manufacturing environment (e.g., a factory or fabrication plant) in which the articles are manufactured. As a particular example, the brain emulation neural network can be configured to process images captured directly following the manufacturing of the articles, e.g., images captured while the articles are on an assembly line. In these implementations, the brain emulation neural network can be required to execute thousands, hundreds of thousands, or millions of times per day. Thus, by training a brain emulation neural network that has relatively few network parameters as described in this specification, a system can configure the brain emulation neural network to properly execute as required in a high-throughput inference environment.

Typically, training a machine learning model to perform defect detection is difficult because of a scarcity of training data. Labeling images of manufactured articles for defects can be highly time-consuming and expensive, and thus typically very few training examples are available (e.g., less than a hundred, less than a thousand, or less than ten thousand training examples). Furthermore, the distribution of training examples can be very imbalanced, because (i) typically a vast majority of manufactured articles do not include any defect, and (ii) even within images of articles that do have a defect, only a small minority of the pixels of the image actually represent the defect (e.g., a scratch or stain that is relatively small compared to the size of the article).

The presence of a brain emulation subnetwork in the architecture of a neural network can overcome the challenges of a small and/or imbalanced data set, significantly improving the training of the neural network to perform defect detection by reducing the amount of time and training examples required to train the neural network. For example, inserting a brain emulation subnetwork into the architecture of a neural network can reduce the amount of time required to achieve a particular prediction performance (e.g., defect detection accuracy) by 100×, 1000×, or 10,000×.

In particular, in some implementations described in this specification, a system can train a brain emulation neural network to perform defect detection using only one or a few parameter updates. That is, the system can process training examples using the brain emulation neural network to generate respective training outputs, and determine a single parameter update from an error of the training outputs; after the single parameter update, the brain emulation neural network can achieve a higher performance than some other neural networks that require hundreds of thousands or millions of parameter updates. In some other implementations, the system can train the brain emulation neural network to achieve high performance in fewer than ten, fewer than a hundred, or fewer than a thousand parameter updates.

As described above, in some implementations a connectivity neural network layer of a brain emulation neural network can divide its layer input into multiple different channels. Then, for each of multiple sub-layers of the connectivity neural network layer, the sub-layer can process a proper subset of the channels of the layer input to generate a respective channel of the layer output of the connectivity neural network layer. Such a connectivity neural network layer can be significantly more efficient, in terms of time, memory, and computations, than a fully-connected neural network layer would be at the same location in the architecture of the brain emulation neural network.

The systems described in this specification can implement a brain emulation neural network having an architecture specified by a synaptic connectivity graph derived from a synaptic resolution image of the brain of a biological organism. The brains of biological organisms may be adapted by evolutionary pressures to be effective at solving certain tasks, e.g., classifying objects or generating robust object representations, and brain emulation neural networks can share this capacity to effectively solve tasks. In particular, compared to other neural networks, e.g., with manually specified neural network architectures, brain emulation neural networks can require less training data, fewer training iterations, or both, to effectively solve certain tasks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A illustrates an example manufacturing environment.

FIG. 1B illustrates an example neural network computing system.

FIG. 2 illustrates example images of manufactured products and network outputs generated from the images by a brain emulation neural network.

FIG. 3 illustrates an example block of neural network layers that includes example connectivity neural network layers and an example brain emulation subnetwork.

FIG. 4 illustrates an example weight matrix of a brain emulation neural network layer determined using biological connectivity.

FIG. 5 illustrates an example neural network training system.

FIG. 6 illustrates an example of generating a brain emulation neural network based on a synaptic resolution image of the brain of a biological organism.

FIG. 7 shows an example data flow for generating a synaptic connectivity graph and a brain emulation neural network based on the brain of a biological organism.

FIG. 8 shows an example architecture mapping system.

FIG. 9 illustrates an example graph and an example sub-graph.

FIG. 10 is a flow diagram of an example process for performing defect detection using a defect detection neural network that includes a brain emulation subnetwork.

FIG. 11 is a flow diagram of an example process for generating a brain emulation neural network.

FIG. 12 is a flow diagram of an example process for determining an artificial neural network architecture corresponding to a sub-graph of a synaptic connectivity graph.

FIG. 13 is a block diagram of an example architecture selection system.

FIG. 14 is a block diagram of an example computer system.

Like reference numbers and designations in the various drawings indicate like elements.

### DETAILED DESCRIPTION

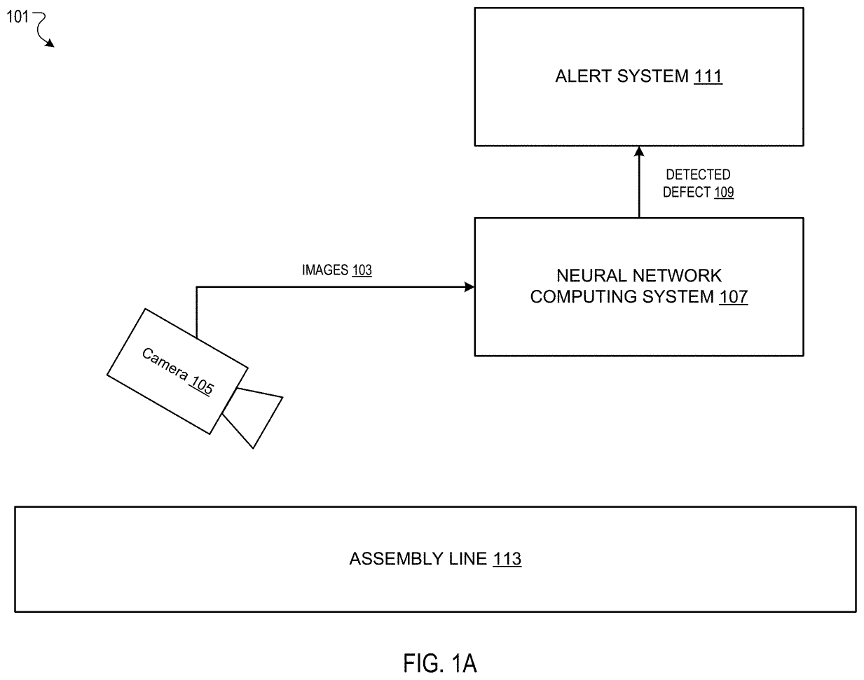

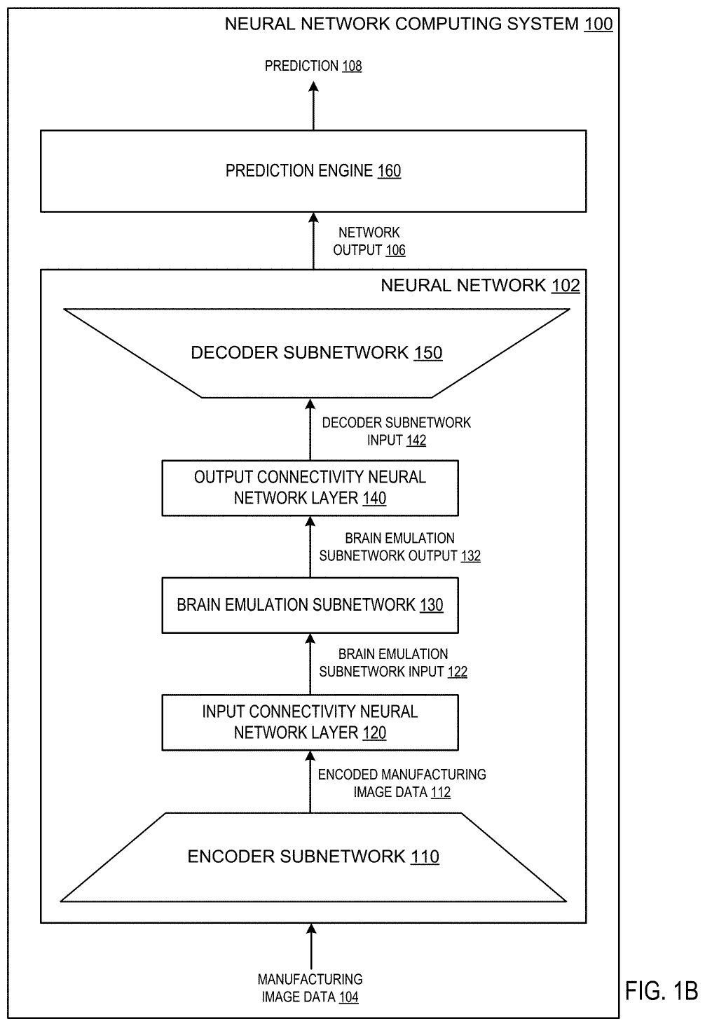

FIG. 1A illustrates an example manufacturing environment 101. The manufacturing environment 101 includes an assembly line 113, a camera 105, a neural network computing system 107, and an alert system 111.

The manufacturing environment 101 is configured to manufacture multiple units of an article of manufacture. For example, the manufacturing environment 101 can be a “high-volume” manufacturing environment in which thousands, tens of thousands, or millions of units of the article are produced per day. As a particular example, the manufacturing environment 101 can be configured to manufacture one or more different components of a vehicle, e.g., camshafts for automobiles.

The assembly line 113 is configured to convey the manufactured articles (or partially-manufactured articles) between two locations in the manufacturing environment 101. The camera 105 is configured to capture one or more respective images 103 of each article on the assembly line 113. That is, the camera and the assembly line 113 can be configured to operate synchronously such that as articles are transported by the assembly line 113, the camera 105 automatically captures a sequence of images 103 of the articles.

In some implementations, instead of or in addition to a camera 105 capturing images 103 of the manufactured articles, the system 101 can include one or more other sensors capturing other types of sensor data representing the manufactured articles. For example, the system 101 can include one or more chemical sensors that are configured to capture sensor data representing types of smells of the manufactures articles. As another example, the system 101 can include one or more temperature sensors configured to determine a temperature of the manufactured articles, and/or one or more pressure sensors configured to determine a pressure of the manufactured articles. Although the below description generally refers to processing images 103 captured by a camera 105, it is to be understood that the same techniques can be used to process any appropriate type of sensor data 103 captured by sensors 105 to predict the presence of defects in manufactured articles.

In some implementations, the articles on the assembly line 113 are fully completed and ready to be released by the manufacturing environment 101, e.g., the articles are being moved by the assembly line 113 for shipment to a customer who is purchasing the articles or to a storage location for storing the articles. In some other implementations, the articles on the assembly line 113 have only partially completed the manufacturing process, e.g., the articles are being moved by the assembly line 113 from a first step of the manufacturing process to a second step of the manufacturing process. As a particular example, the articles on the assembly line 113 can be sub-components of a final product that the manufacturing environment 101 is configured to produce. Although the below description generally refers to images of manufactured articles, it is to be understood that the same techniques can be applied to images of partially-manufactured articles.

The camera 105 is configured to provide the images 103 of the articles to the neural network computing system 107 for detecting possible defects in the articles. The neural network computing system 107 is configured to process the images 103 using a brain emulation neural network to generate a prediction about whether the manufactured articles represented in the images 103 have a defect.

In some implementations, each image 103 captured by the camera 105 depicts a single manufactured article, and the neural network computing system 107 is configured to detect defects in the single manufactured article. In some other implementations, each image 103 depicts multiple different manufactured articles (e.g., multiple units of the same type of manufactured article), and the neural network computing system 107 is configured to detect defects in any one of the multiple different manufactured articles. For example, the brain emulation neural network of the neural network computing system 107 can be configured to generate a network output that identifies a particular one or more of the multiple different manufactured articles that may be defective. As another example, the brain emulation neural network can be configured to generate a network output that generally identifies that a defect may be present among the multiple different manufactured articles without identifying a particular one of the manufactured articles. Although the below description generally refers to processing images that depict a single manufactured article, it is to be understood that the same techniques can be applied when processing images depicting multiple different manufactured articles.

The brain emulation neural network includes one or more brain emulation neural network layers whose parameters have been determined according to the biological connectivity between neuronal elements in the brain of a biological organism, e.g., synaptic connectivity between neurons in the brain of a biological organism. The brain emulation neural network has been configured through training to leverage structure of the biological connectivity (which has been, e.g., determined through evolutionary pressures on the species of the biological organism) to extract useful information from the images 103 to predict the presence of defects in the manufactured articles. For example, the neural network computing system 107 can be the neural network computing system 100 described below with reference to FIG. 1B.

After the brain emulation neural network generates an output in response to processing an image 103 of a manufactured article, the neural network computing system 107 can process the output to generate a prediction of whether the manufactured article represented in the image 103 includes a defect 109. For example, if the brain emulation neural network is configured to generate an output value between 0 and 1 representing the likelihood of the presence of the defect 109, then the neural network computing system 107 can determine if the output value exceeds a predetermined threshold. This process is described in more detail below with reference to FIG. 1B.

In some implementations, the neural network computing system 107 can further process the network output of the brain emulation neural network to generate the data provided to the alert system 111 representing the detected defect 109. For example, the neural network computing system 107 can process the network output to identify a location of the detected defect 109 on the particular manufactured product, or a component of the particular manufactured product that has the detected defect 109. This process is discussed in more detail below with reference to FIG. 1B.

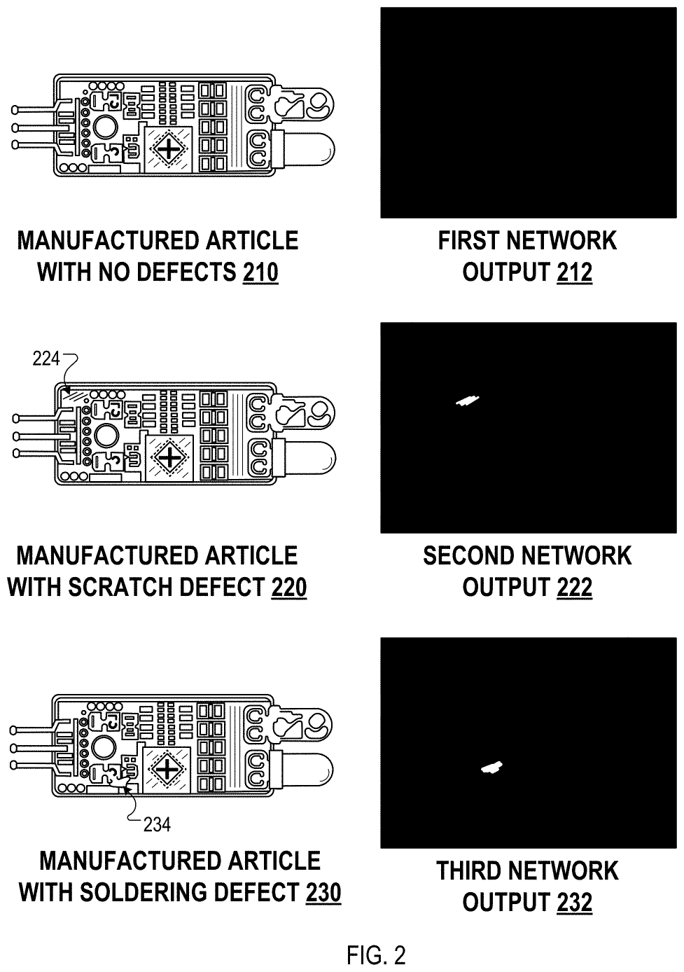

When the neural network system 107 generates a prediction that a particular manufactured article includes a defect 109, the neural network computing system can provide data representing the detected defect 109 to the alert system 111. For example, the neural network computing system 107 can provide an identification of the particular manufactured article, e.g., a serial number. Instead or in addition, the neural network computing system 107 can provide the image 103 of the particular manufactured article. Instead or in addition, the neural network computing system 107 can provide the network output generated by the brain emulation neural network in response to processing the image 103 of the particular manufactured product, e.g., a semantic segmentation of the image 103 that identifies one or more pixels that represent the detected defect 109. Example network outputs for defect detection generated by a brain emulation neural network are described in more detail below with reference to FIG. 2.

The alert system 111 is configured to take appropriate action in response to the detected defect 109. For example, the alert system 111 can generate an alert for a user of the alert system 111 to report the detected defect 109. As a particular example, the alert system 111 can display, on a user device, data representing the detected defect 109 (e.g., the image 103 of the particular manufactured article or an updated image in which the detected defect 109 is visually identified), and the user can review the data to determine whether the particular manufactured article actually has the detected defect 109.

In some implementations, the alert system 111 can automatically remove the particular manufactured article from the manufacturing pipeline, e.g., by sending data to the assembly line 113 (or another component of the manufacturing environment 101) to remove the particular manufactured article from the assembly line 113. In some such implementations, the particular manufactured article can be provided for further inspection. For example, a user in the manufacturing environment 101 can manually inspect the particular manufactured article to determine whether the detected defect 109 is present.

As another example, an external system can further inspect the particular manufactured article, e.g., by obtaining additional images (e.g., higher-resolution images or images focused on a predicted location of the detected defect) or other sensor data representing the particular manufactured article. For instance, the external system can process the additional images and/or other sensor data using the brain emulation neural network of the neural network computing system 107 or using one or more other machine learning models configured to perform defect detection.

As a particular example, if the neural network computing system 107 is configured to process an image 103 of a manufactured article and to generate a binary indication of whether the manufactured article includes a defect, then in response to receiving data indicating a defect 109 the alert system 111 can send a request to an external system to (i) capture a higher-resolution image of the manufactured article and (ii) process the higher-resolution image using a machine learning model (e.g., another brain emulation neural network) to generate a semantic segmentation of the higher-resolution image. Thus, the external system can more precisely identify a location or type of the defect 109.

As another particular example, if the brain emulation neural network is configured to process an image 103 of a manufactured article and to generate a predicted location of an identified defect 109, then the alert system 111 can send a request to an external system to (i) capture an image of the identified location on the manufactured article and (ii) process the image using a machine learning model (e.g., another brain emulation neural network) to generate a further prediction about the defect 109, e.g., to confirm the presence of the defect 109.

In this specification, a “manufactured article” is any physical item or set of items that has been produced during a manufacturing process. The articles manufactured by the manufacturing environment 101 can be any appropriate type of article. For example, the manufactured articles can be textiles, food products, electronics, chemical products, metal parts, wood-based products, and so on.

In this specification, a “defect” of a manufactured article is any feature or characteristic of the manufactured article that was not an intended effect of the manufacturing process. In this specification, a manufactured article is called “defective” if it includes one or more defects. Using techniques described in this specification, a system can be configured to detect any appropriate type of defect in a manufactured article. Example defects are described in more detail below.

FIG. 1B shows an example neural network computing system 100. The neural network computing system 100 is an example of a system implemented as computer programs on one or more computers in one or more locations in which the systems, components, and techniques described below are implemented.

The neural network computing system 100 includes a neural network 102 and a prediction engine 160. The neural network 102 includes an encoder subnetwork 110, an input connectivity neural network layer 120, a brain emulation subnetwork 130, an output connectivity neural network layer 140, and a decoder subnetwork 150.

The neural network system 100 is configured to process manufacturing image data 104 that represents one or more images of a manufactured article, and to generate a prediction 108 of whether the manufactured article has a defect. The manufacturing image data 104 can be captured by one or more cameras (or generated from raw image data captured by one or more cameras) in any appropriate environment. For example, the manufacturing image data 104 can be captured by one or more cameras in the manufacturing environment in which the article was manufactured, as described above with reference to FIG. 1A.

The manufacturing image data 104 can include images that characterize any appropriate range of electromagnetic frequencies. For instance, the manufacturing image data 104 can include one or more visible-light images of the manufactured article, e.g., RGB images. Instead or in addition, the manufacturing image data 104 can include one or more microscopic images, one or more infrared images, one or more x-ray images, one or more ultraviolet images, one or more multispectral images, and/or one or more hyperspectral images of the manufactured article. As another particular example, the manufacturing image data 104 can include one or more LIDAR images of the manufactured article. Each LIDAR image can include multiple points that are each associated with (i) a three-dimensional location in a common coordinate system and (ii) optionally, one or more other parameters (e.g., an intensity parameter). Each point in the LIDAR image can represent a respective point on the manufactured article, such that collectively the LIDAR image represents the shape of the manufactured article (or a portion of the manufactured article).

The neural network 102 is configured to process the manufacturing image data 104 and to generate a network output 106 that characterizes any possible defects in the manufactured article depicted in the manufacturing image data 104. The prediction engine 160 is configured to process the network output 106 and to generate the prediction 108 of whether the manufactured article is defective; this process is described in more detail below.

The prediction 108 generated from the manufacturing image data 104 can be any appropriate prediction characterizing whether the manufactured article has a defect, e.g., any kind of score, classification, or regression output based on the manufacturing image data 104. For example, the prediction 108 can represent a predicted semantic segmentation of the manufacturing image data 104. For example, the prediction 108 can identify, for each element (e.g., pixel) of the manufacturing image data 104, whether or not the element represents a defect of the manufactured article; that is, the prediction 108 can be a binary semantic segmentation of the manufacturing image data 104. As another example, the prediction 108 can identify, for each element of the manufacturing image data 104, a type of defect that the element represents (e.g., whether the element represents a scratch, stain, tear, and so on); that is, the prediction 108 can be a multi-class semantic segmentation of the manufacturing image data 104.

As another example, the prediction 108 can delineate one or more defects of the manufactured article represented by the manufacturing image data 104. For instance, the prediction 108 can define a bounding box (or an ellipse or any other appropriate one-dimensional curve) that encloses elements of the manufacturing image data 104 that represent a defect in the manufactured article. Instead or in addition, the prediction 108 can define the real-world geometry of possible defects in the manufactured article, e.g., by identifying, for each defect, real-world coordinates of the defect on the manufactured article, in a three-dimensional coordinate system defined with respect to the manufactured article.

In some implementations, instead of processing the manufacturing image data 104 directly, the neural network system 100 first generates a network input from the manufacturing image data 104, and the neural network 102 then processes the network input to generate the network output 106. For example, the neural network system 100 can pre-process the manufacturing image data 104 to generate the network input, e.g., by applying one or more denoising techniques or orthorectification techniques to the manufacturing image data 104. Orthorectification is a process of processing an image to remove the effects of the perspective (e.g., the tilt) from which the image was captured.

Instead or in addition to pre-processing the manufacturing image data 104, the neural network system 100 can generate the network input by adding one or more other elements to the network input in addition to the manufacturing image data 104. The one or more additional elements can include any appropriate data characterizing the manufactured article represented by the manufacturing image data 104. For example, the additional elements can identify a particular manufacturing environment (e.g., a particular factory or fabrication plant) at which the manufacturing image data 104 was captured. As another example, the additional elements can identify one or more classes, from a set of multiple classes, to which the manufactured article belongs. That is, if the neural network 102 is configured to process images of manufactured articles having multiple different types, then the additional elements can identify a particular type of the manufactured article represented by the manufacturing image data 104. As a particular example, the neural network 102 can be configured to process images of manufactured articles having multiple different colors (e.g., a single product that has multiple color options), and the additional elements can include an identification of the color that the manufactured article represented by the manufacturing image data 104 is supposed to be.

Although the below description generally refers to processing the manufacturing image data 104 directly, it is to be understood that a neural network can be configured to process any appropriate network input generated from the manufacturing image data 104.

As described above with reference to FIG. 1A, instead of or in addition to image data 104, the neural network computing system 100 can be configured to process any appropriate type of sensor data 104 representing manufactured articles to generate a prediction 108 of whether the manufactured articles are defective.

The encoder subnetwork 110 of the neural network 102 is configured to process the manufacturing image data 104 and to encode the manufacturing image data 104, generating encoded manufacturing image data 112. The encoded manufacturing image data 112 is an embedding of the manufacturing image data 104.

In this specification, an encoder subnetwork of a neural network is a subnetwork that includes one or more non-biological neural network layers and that, in some implementations, reduces the size of one or more dimensions of the network input to the neural network (or, in some implementations, reduces the size of one or more dimensions of a hidden representation of the network input). That is, an encoder subnetwork is configured to process an encoder subnetwork input (generated from, or equal to, the network input to the neural network) and to generate an encoder subnetwork output, where in some implementations, the encoder subnetwork output has a smaller size than the encoder subnetwork input (e.g., as measured by the respective resolutions of the encoder subnetwork input and the encoder subnetwork output). Thus, in the example depicted in FIG. 1B, the encoded manufacturing image data 112 has a smaller size than the manufacturing image data 104. In some other implementations, the encoder subnetwork 110 can maintain the resolution of the manufacturing image data 104 when generating the encoded manufacturing image data 112. In some other implementations, the encoder subnetwork 110 can increase the size of one or more dimensions of the manufacturing image data 104. For example, if the manufacturing image data 104 includes an image with c₁ channels (e.g., an RGB image where c₁=3), then the encoded manufacturing image data 112 can include an encoded image with c₂ channels, where c₁<c₂. As a particular example, if the manufacturing image data 104 includes an m₁×n₁×c₁ image, then the encoded manufacturing image data 112 can include an m₂×n₂×c₂ encoded image, where m₁>m₂, n₁>n₂, and c₁<c₂.

The encoder subnetwork 110 can include any appropriate type of non-biological neural network layers, e.g., one or more convolutional neural network layers, one or more recurrent neural network layers, one or more feedforward neural network layers, and/or one or more self-attention neural network layers. Example architectures for the neural network 102 are discussed in more detail below.

In some implementations, in addition to one or more non-biological neural network layers, the encoder subnetwork 110 also includes one or more brain emulation neural network layers. In some other implementations, the encoder subnetwork 110 is a non-biological subnetwork, i.e., does not include any brain emulation neural network layers. The input connectivity neural network layer 120 is a non-biological neural network layer directly preceding the brain emulation subnetwork 130 of the neural network 102. The input connectivity neural network layer 120 is configured to process the encoded manufacturing image data 112 and to generate a brain emulation subnetwork input 122 for the brain emulation subnetwork 130.

The brain emulation subnetwork input 122 can have a predefined dimensionality, e.g., a dimensionality required by the brain emulation neural network architecture of the brain emulation subnetwork 130 determined using biological connectivity. The input connectivity neural network layer 120 can be configured to project the encoded manufacturing image data 112 to the predefined dimensionality of the brain emulation subnetwork input 122. That is, the input connectivity neural network layer 120 can be configured to map the output of the encoder subnetwork 110 to the required dimensionality for processing by the brain emulation subnetwork 130.

After the neural network 102 has been trained, the input connectivity neural network layer 120 is configured to generate a brain emulation subnetwork input 122 that is optimized for the brain emulation subnetwork 130, e.g., that encodes maximal information from the manufacturing image data 104 that is usable by the brain emulation subnetwork 130. That is, the input connectivity neural network layer 120 can be configured through training (e.g., training that includes processing multiple different sets of manufacturing image data 104) to encode, into the brain emulation subnetwork input 122 for eventual processing by the brain emulation subnetwork 130, the information from the manufacturing image data 104 that is useful for generating the prediction 108 of whether the manufactured article represented by the manufacturing image data 104 is defective.

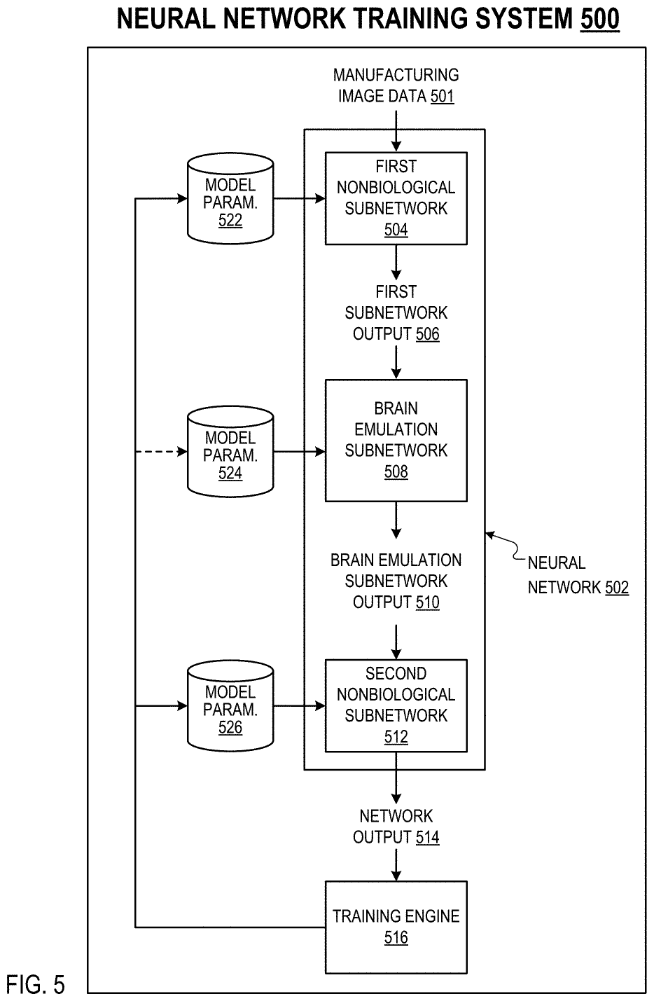

Example techniques for training a neural network that includes a brain emulation subnetwork to perform defect detection on images of manufactured articles are described below with reference to FIG. 5.

In some implementations, the input connectivity neural network layer 120 is a fully-connected neural network layer. That is, each element of the encoded manufacturing image data 112 can be used to generate each element of the brain emulation subnetwork input 122.

In some other implementations, the input connectivity neural network layer 120 divides the encoded manufacturing image data 112 into multiple channels, and generates respective channels of the brain emulation subnetwork input 122 by processing respective proper subsets of the channels of the encoded manufacturing image data 112. That is, each element of the brain emulation subnetwork input 112 can be generated from a proper subset of the elements of the encoded manufacturing image data 112. Typically, such a connectivity neural network layer has fewer trained parameters than a fully-connected neural network, thus requiring less time to train and execute at inference.

In other words, the output of a connectivity neural network layer (e.g., the brain emulation subnetwork input 122 generated by the input connectivity neural network layer 120) can include multiple different components, and the connectivity neural network layer can generate each component by processing only a respective proper subset of the input to the connectivity neural network layer (e.g., the encoded manufacturing image data 112).

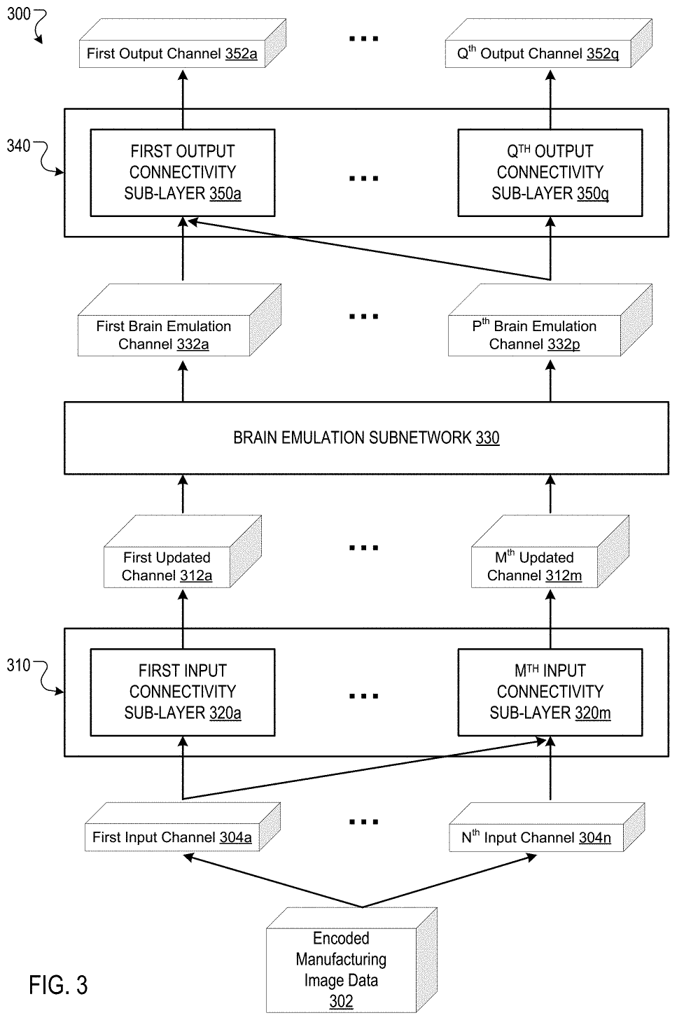

Example connectivity neural network layers for processing hidden representations of manufacturing image data are described in more detail below with reference to FIG. 3.

The brain emulation subnetwork 130 is configured to process the brain emulation subnetwork input 122 and to generate a brain emulation subnetwork output 132, which can be processed by subsequent neural network layers in the neural network 102. The brain emulation subnetwork input 122 and the brain emulation subnetwork output 132 may be represented in any appropriate numerical format, for example, as vectors or as matrices.

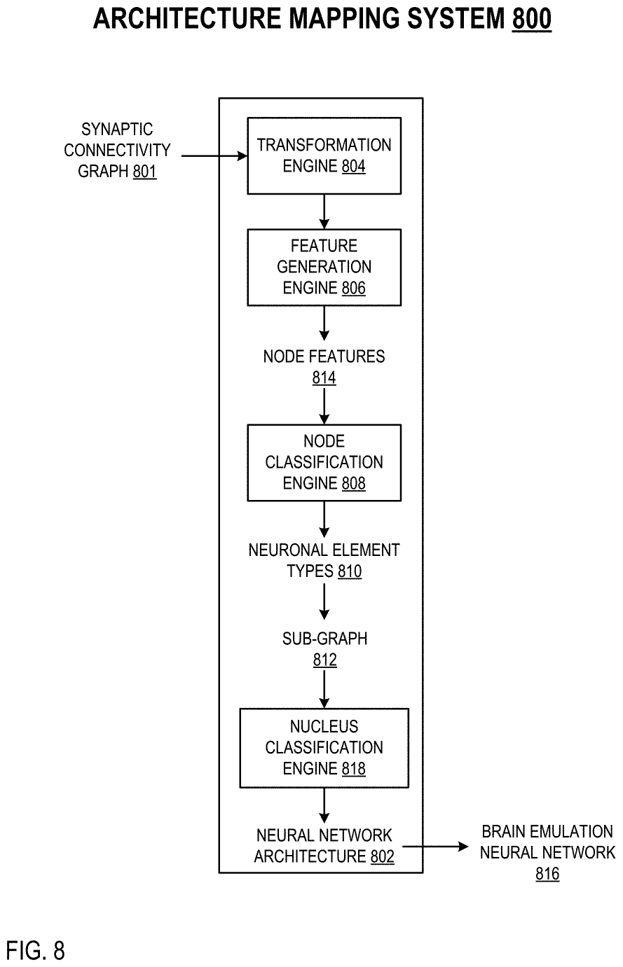

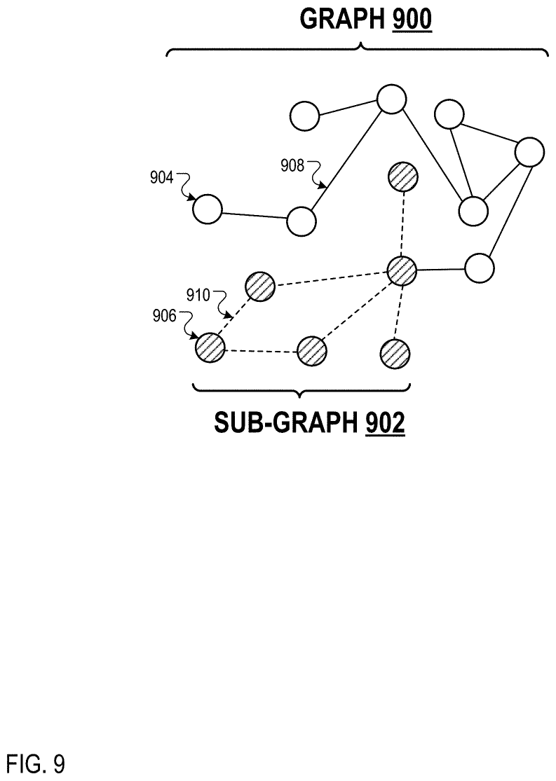

The brain emulation subnetwork 130 can have an architecture that is based on a synaptic connectivity graph representing biological connectivity between neuronal elements in the brain of the biological organism, e.g., synaptic connectivity between neurons in the brain of a biological organism. An example process for determining a network architecture using a synaptic connectivity graph is described below with reference to FIG. 8. In some implementations, the architecture of the brain emulation subnetwork 130 can be specified by the biological connectivity between neuronal elements of a particular type in the brain, e.g., neuronal elements that process sensory inputs that are of the same type (or that are otherwise similar to) the manufacturing image data 104 that the neural network is configured to process, e.g., neuronal elements from the visual system. This process is described in more detail below with reference to FIG. 8 and FIG. 9.

The output connectivity neural network layer 140 is a non-biological neural network layer directly following the brain emulation subnetwork 130 of the neural network 102. The output connectivity neural network layer 140 is configured to process the brain emulation subnetwork output 132 and to generate a decoder subnetwork input 142 for the decoder subnetwork 150. After the neural network 102 has been trained, the output connectivity neural network layer 140 is configured to generate a decoder subnetwork input 142 that is optimized for the decoder subnetwork 150, e.g., that encodes maximal information from the brain emulation subnetwork output 132 (and originally from the manufacturing image data 104) that is usable by the decoder subnetwork 150 for identifying defects in the manufactured article represented by the manufacturing image data 104.

The brain emulation subnetwork 130 can be configured to generate a brain emulation subnetwork output 132 that has a predefined dimensionality, e.g., a dimensionality required by the brain emulation neural network architecture of the brain emulation subnetwork 130 determined using biological connectivity. The output connectivity neural network layer 140 can be configured to project the brain emulation subnetwork output 132 from the predefined dimensionality of the brain emulation subnetwork output 132 to a dimensionality that is required by the decoder subnetwork 150. That is, the output connectivity neural network layer 140 can be configured to map the output of the brain emulation subnetwork 130 to the required dimensionality for processing by the decoder subnetwork 150.

In some implementations, the output connectivity neural network layer 140 is a fully-connected neural network layer. In some other implementations, the output connectivity neural network layer 140 divides the brain emulation subnetwork output 132 into multiple channels, and generates respective channels of the decoder subnetwork input 142 by processing respective proper subsets of the channels of the brain emulation subnetwork output 132. Generally, the input connectivity neural network layer 120 and the output connectivity neural network layer 140 can be the same type of neural network layer (e.g., both fully-connected neural network layers) or different types of neural network layer.

The decoder subnetwork 150 of the neural network 102 is configured to process the decoder subnetwork input 142 to generate the network output 106.

In this specification, a decoder subnetwork of a neural network is a subnetwork that includes one or more non-biological neural network layers and that, in some implementations, increases the size of one or more dimensions of a hidden representation of the network input to the neural network. That is, a decoder subnetwork is configured to process a decoder subnetwork input (generated from the network input to the neural network) and to generate a decoder subnetwork output, where in some implementations, the decoder subnetwork output has a larger size than the decoder subnetwork input (e.g., as measured by the respective resolutions of the decoder subnetwork input and the decoder subnetwork output). Thus, in the example depicted in FIG. 1B, the network output 106 has a larger size than the decoder subnetwork output 142. In some other implementations, the decoder subnetwork 150 can maintain the resolution of the decoder subnetwork input 142 when generating the network output 106. In some other implementations, the decoder subnetwork 150 can decrease the size of one or more dimensions of the decoder subnetwork input 142.

The decoder subnetwork 150 can include any appropriate type of non-biological neural network layers, e.g., one or more convolutional neural network layers, one or more recurrent neural network layers, one or more feedforward neural network layers, and/or one or more self-attention neural network layers.

In some implementations, in addition to one or more non-biological neural network layers, the decoder subnetwork 150 also includes one or more brain emulation neural network layers. In some other implementations, the decoder subnetwork 150 is a non-biological subnetwork, i.e., does not include any brain emulation neural network layers.

In some implementations, the brain emulation subnetwork input 122 is at a “bottleneck” of the neural network 102. In this specification, a bottleneck of a neural network is a location in the architecture of the neural network at which the hidden representation of the network input to the neural network is smallest. That is, the brain emulation subnetwork input 122 (or the brain emulation subnetwork output 132, in some implementations in which the brain emulation subnetwork 130 itself changes the size of the hidden representation) can be the smallest hidden representation of the manufacturing image data 104, of all hidden representations of the manufacturing image data 104 generated by respective neural network layers of the neural network 102.

The neural network 102 can have any appropriate network architecture.

For example, the neural network 102 can be a convolutional neural network that includes one or more convolutional neural network layers. Each convolutional neural network layer of the neural network 102 can apply a learned convolutional kernel to the manufacturing image data 104 (or to hidden representations of the manufacturing image data 104) to generate the network output 106. As a particular example, the encoder subnetwork 110 can process the manufacturing image data 104 using a sequence of dimension-reducing convolutional neural network layers to generate the encoded manufacturing image data 112, and the decoder subnetwork 150 can process the decoder subnetwork input 142 using a sequence of dimension-increasing convolutional neural network layers to generate the network output 106.

Instead or in addition to non-biological convolutional neural network layers, the brain emulation subnetwork 130 can include one or more convolutional neural network layers whose respective convolutional kernels have been generated using the biological connectivity between neuronal elements in the brain of the biological organism. As a particular example, the elements of the convolutional kernel of a convolutional neural network layer in the brain emulation subnetwork 130 can be the same as a subset of the elements of a synaptic connectivity graph; e.g., the elements of the convolutional kernel can be the elements in a particular row or column of the synaptic connectivity graph. Generating convolutional kernels using biological connectivity is discussed in more detail in U.S. patent application Ser. No. 17/236,647, which is herein incorporated by reference in its entirety.

As another example, the neural network 102 can be an autoencoder neural network, where the encoder subnetwork 110 is the encoder of the autoencoder and the decoder subnetwork 150 is the decoder of the autoencoder. That is, the neural network 102 can be an autoencoder neural network that is configured to generate an embedding of the manufacturing image data 104 (e.g., using the encoder subnetwork 110, where the embedding is the encoded manufacturing image data 112) and then process the embedding to reconstruct the manufacturing image data 104 (e.g., using the decoder subnetwork 150, where the network output 106 is a predicted reconstruction of the manufacturing image data 104). As a particular example, the neural network 102 can be a variational autoencoder that models the latent space of the generated embeddings using a mixture of distributions instead of a fixed vector.

In these implementations, the neural network computing system 100 can be configured to predict whether the manufactured article is defective by performing anomaly detection on the manufacturing image data 104 using the autoencoder neural network 102. Based on a difference between the manufacturing image data 104 and the predicted reconstruction 106 of the manufacturing image data 104, the neural network computing system 100 can generate a prediction 108 of whether there are one or more anomalies in the manufacturing image data 104, indicating a possible defect in the manufactured article. Because the neural network 102 has been configured through training to generate network outputs 106 that closely resemble the manufacturing image data 104, if the neural network system 100 determines that the difference between (i) a particular network output 106 generated from a particular set of manufacturing image data 104 and (ii) the particular set of manufacturing image data 104 is larger than normal, the neural network system 100 can determine that the particular set of manufacturing image data 104 is atypical in some way and possibly indicative of a defect in the manufactured article.

In some such implementations, to train the autoencoder neural network, a training system can evaluate an objective function that measures an error between: (i) the manufacturing image data 104, and (ii) the predicted reconstruction 106 of the manufacturing image data 104. The training system can then update at least some of the neural network parameters of the neural network 102 using respective gradients of the objective function.

As another example, the neural network 102 can have an architecture in which one or more neural network layers of the decoder subnetwork 150 are configured to process hidden representations of the manufacturing image data 104 generated by respective neural network layers of the encoder subnetwork 110, instead of or in addition to processing the output of the preceding neural network layer in the decoder subnetwork 150.

For instance, the encoder subnetwork 110 can include a sequence of multiple encoder blocks. Each encoder block can be configured to process a respective encoder block input to generate a respective encoder block output. For each encoder block, the spatial resolution of the encoder block output can be lower than the spatial resolution of the encoder block input. For each encoder block that is after an initial encoder block in the sequence of encoder blocks, the encoder block input can include a previous encoder block output of a previous encoder block in the sequence of encoder blocks.

Similarly, the decoder subnetwork 150 can include a sequence of multiple decoder blocks. Each decoder block can be configured to process a respective decoder block input to generate a respective decoder block output. For each decoder block, the spatial resolution of the decoder block output can be greater than the spatial resolution of the decoder block input. For each decoder block that is after an initial decoder block in the sequence of decoder blocks, the decoder block input can include (i) an intermediate output of a respective encoder block, and (ii) a previous decoder block output of a previous decoder block. For example, for each decoder block, the intermediate output of the respective encoder block and the previous decoder block output of the previous decoder block can have the same resolution, such that the decoder block can concatenate the two inputs and process the concatenation.

As a particular example, each encoder block and each decoder block can include one or more two-dimensional convolutional neural network layers, one or more three-dimensional convolutional neural network layers, or both.

The prediction engine 160 is configured to process the network output 106 to generate the prediction 108 about whether the manufactured article represented by the manufacturing image data 104 has a defect.

For example, the neural network system 100 can be configured to determine a prediction 108 that includes a semantic segmentation of the manufacturing image data 104. In these implementations, for each element of the manufacturing image data 104 (e.g., for each pixel of an RGB image in the manufacturing image data 104 or for each point of a LIDAR image in the manufacturing image data 104) and for each of multiple classes to which the element can be assigned, the network output 106 can include a respective score (e.g., a value between 0 and 1) that represents a likelihood that the element belongs to the class.

In some implementations, the prediction engine 160 can process the network output 106 representing the semantic segmentation to generate a prediction 108 that includes, for each element in the manufacturing image data 104, a final prediction of one or more classes to which the element belongs. For example, the prediction engine 160 can assign each element to the class that has the highest score corresponding to the element in the network output 106. As a particular example, the semantic segmentation can be a binary segmentation that identifies, for each element of the manufacturing image data 104, a binary prediction of whether or not the element represents a defect on the manufactured article. As another particular example, the semantic segmentation can be a multi-class segmentation that includes multiple classes representing respective different types of defect that the manufactured article may have. For instance, the multiple classes can include respective classes representing one or more of: scratches, stains, heat damage, cracks, dents, foreign material, glue, paint, or soldering defects.

Instead or in addition, the prediction engine 160 can process the network output 106 representing the semantic segmentation to generate a prediction 108 that includes a binary indication of whether the manufactured article represented by the manufacturing image data 104 includes a defect. As a particular example, the prediction engine 160 can determine that the manufactured article includes a defect if more than N pixels of the manufacturing image data 104 have a score for a defect class (e.g., a binary defect class) that exceeds a predetermined threshold (e.g., 0.25, 0.5, 0.75, or 0.9), and/or if more than N pixels of the manufacturing image data 104 have multiple defect classes (e.g., multiple classes representing respective types of defect) whose sum exceeds a predetermined threshold (e.g., 0.25, 0.5, 0.75, or 0.9), where N≥1.

Instead or in addition, the neural network system 100 can be configured to generate a prediction 108 that delineates one or more defects identified in the manufacturing image data 104, e.g., by generating a prediction 108 that defines one or more bounding boxes that each enclose elements of the manufacturing image data 104 representing a respective identified defect in the manufactured article. As a particular example, the prediction engine 160 can determine a semantic segmentation of the manufacturing image data 104 from the network output 106, as described above, and use the semantic segmentation to determine the coordinates of the one or more bounding boxes. For instance, the prediction engine 160 can determine contiguous elements of the manufacturing image data 104 that were each assigned the same class in the semantic segmentation (e.g., that were each assigned the positive “defect” class in a binary segmentation, or a class corresponding to a particular type of defect in a multi-class segmentation). The prediction engine 160 can then determine a bounding box (or ellipse, or any other appropriate shape) that bounds the determined contiguous elements.

In some such implementations, the prediction engine 160 can determine, from the determined delineation of a possible defect represented in the manufacturing image data 104, corresponding real-world coordinates of the possible defect on the manufactured article itself. That is, if the determined delineation (e.g., the determined bounding box surrounding the pixels representing the defect) are represented in a two-dimensional coordinate system defined by the manufacturing image data 104, the prediction engine 160 can process the determined delineation to translate the delineation into real-world coordinates that identify the particular location of the defect on the manufactured article. For example, the prediction engine 160 can obtain data identifying a location and pose, in the real world, of the one or more cameras that captured the manufacturing image data 104. The prediction engine 160 can then use the location and pose of the cameras to translate the determined delineation, in the coordinate system defined by the manufacturing image data 104, into real-world coordinates defined with respect to the manufactured article. As a particular example, the prediction engine 160 can identify a particular component of the manufactured article that is defective.

As another example, in implementations in which the network output 106 is a reconstructed version of the manufacturing image data 104, the prediction engine 160 can determine a difference between the network output 106 and the manufacturing image data 104 in order to determine whether the manufacturing image data 104 is anomalous, as described above.

As another example, the neural network system 100 can be configured to generate a prediction 108 that classifies the manufacturing image data 104 as a whole into a set of categories, including a “no defect” category and at least one “defect” category. For instance, the network output 106 can identify, for each possible category of the manufacturing image data 104, a value (e.g., a value between 0 and 1) representing a likelihood that the manufacturing image data 104 belongs to the category (e.g., where the final neural network layer of the neural network 102 is a softmax layer). The prediction engine 160 can then generate a prediction 108 that includes a binary indication of whether the manufactured article represented by the manufacturing image data 104 includes a defect. As a particular example, the prediction engine 160 can determine that the manufactured article includes a defect if a score for a defect class (e.g., a binary defect class) and/or the summed scores for multiple defect classes (e.g., multiple classes representing respective types of defect) exceeds a predetermined threshold (e.g., 0.25, 0.5, 0.75, or 0.9). Instead or in addition, the prediction engine 160 can generate a prediction 108 that identifies one or more of the most-likely categories for the manufacturing image data 104 as defined by the network output 106, e.g., by identifying a particular type of defect that the manufactured article is predicted to have.

In some implementations, the prediction 108 is the same as the network output 106. That is, the neural network 102 can be configured to directly generate the prediction 108 without requiring further processing by a prediction engine 160.

After generating the prediction 108 about the manufacturing image data 104, the neural network computing system 100 can provide the prediction 108 to one or more downstream systems, e.g., for storage, further processing, or presentation to a user. For example, as described above with reference to FIG. 1A, if the prediction 108 identifies a defect in the manufactured article, then the neural network computing system 100 can provide the prediction 108 to an alert system that alerts a user of the neural network computing system 108 to remove the manufactured article from the manufacturing environment, e.g., for further inspection.

In some implementations, the operations of the neural network computing system 100 are executed on a single device, e.g., a parallel processing device such as a graphics processing unit (GPU) or tensor processing unit (TPU).

In some such implementations, the neural network 102 can be configured to execute in a resource-constrained environment, e.g., an edge device such as a mobile phone, tablet, laptop, drone, scientific computing device, and so on. In these implementations, the neural network computing system 100 can be trained to perform at a high level (e.g., in terms of prediction accuracy) even with very few model parameters compared to other neural networks. Example techniques for training the neural network 102 are described below with reference to FIG. 5.

The inclusion of the brain emulation subnetwork 130 in the architecture of the neural network 102 can provide this high efficiency; because the parameters and architecture of the brain emulation subnetwork 130 have been determined using biological connectivity, as described in more detail below, the subnetwork 130 is configured to extract maximal information from the brain emulation subnetwork input 122 with relatively few operations. For example, while some existing techniques require the training and execution of neural networks that include millions or billions of parameters in order to achieve high performance, the neural network 102 can include, e.g., merely hundreds, thousands, or hundreds of thousands of parameters and still achieve high performance.

For example, the neural network computing system 100 can be deployed on a long-term device that is installed in a location (e.g., within the manufacturing environment as described above with reference to FIG. 1A) and, over the course of multiple days, months, or years, continuously captures images of manufactured articles and processes the images using the neural network computing system 100.

In some other implementations the operations of the neural network 102 when processing the manufacturing image data 104 can be distributed across a system of multiple devices that are communicatively connected.

FIG. 2 illustrates example images of manufactured products 210, 220, and 230 and respective network outputs 212, 222, and 232 generated from the images by a brain emulation neural network.

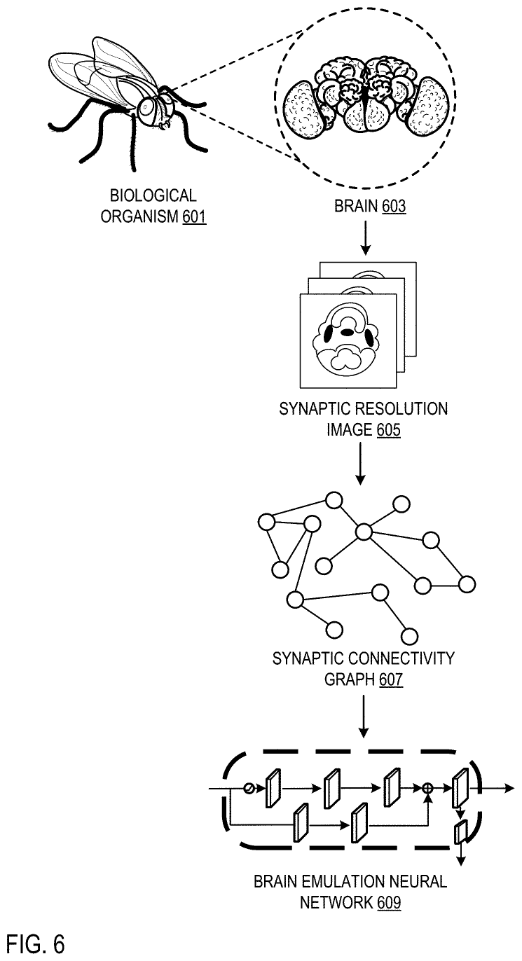

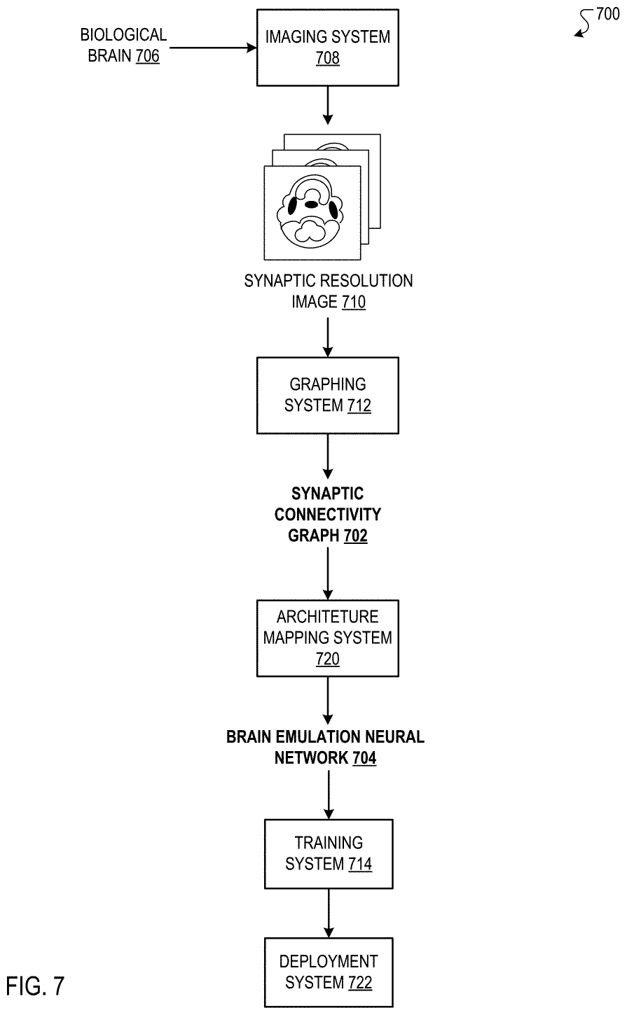

The brain emulation neural network can include one or more brain emulation neural network layers that are configured to process the images 210 (or respective hidden representations thereof) to generate the network outputs 212, 222, and 232. The network parameters and/or network architecture of the brain emulation neural network can be determined using biological connectivity between neuronal elements in the brain of the biological organism, as described in more detail below with reference to FIG. 6, FIG. 7, and FIG. 8. As a particular example, the brain emulation neural network can be configured similarly to the neural network 102 described above with reference to FIG. 1B.

The first manufactured article 210 does not include any defects. The brain emulation neural network can process the image of the first manufactured article 210 to generate the first network output 212 characterizing a prediction of whether the first manufactured article 210 has a defect. In particular, the first network output 212 represents a predicted binary semantic segmentation of the image of the first manufactured article 210 into two classes: (i) a first class of pixels that represent a defect (illustrated in FIG. 2 as white pixels) and (ii) a second class of pixels that do not represent a defect (illustrated in FIG. 2 as black pixels). Because the first manufactured article 210 does not have any defect, each pixel of the first network output 212 is black, indicating no defect.

The second manufactured article 220 has a scratch defect 224. The brain emulation neural network can process the image of the second manufactured article 220 to generate a second network output 222 representing a predicted binary semantic segmentation of the image of the second manufactured article 222. In particular, the second network output 222 includes a set of white pixels, corresponding to the pixels of the image of the second manufactured article 220 that depict the scratch defect 224, indicating a defect on the portion of the second manufactured article 220 represented by the white pixels.

The third manufactured article 230 has a soldering defect 234. The brain emulation neural network can process the image of the third manufactured article 230 to generate a third network output 232 representing a predicted binary semantic segmentation of the image of the third manufactured article 232. In particular, the third network output 232 includes a set of white pixels, corresponding to the pixels of the image of the third manufactured article 230 that depict the soldering defect 234, indicating a defect on the portion of the third manufactured article 230 represented by the white pixels.

As described above with reference to FIG. 1B, in some implementations, the network outputs 212, 222, and 232 can represent a multi-class segmentation of the respective images. That is, the white pixels of the second network output 222 can identify a first class corresponding to scratch defects, while the white pixels of the third network output 232 can identify a second class corresponding to soldering defects.

As described above with reference to FIG. 1B, in some implementations, the network outputs 212, 222, and 232 can be further processed to generate one or more additional predictions about the respective manufactured products 210, 220, and 230, e.g., to identify a boundary for each identified defect.

FIG. 3 illustrates an example block 300 of neural network layers that includes example connectivity neural network layers 310 and 340 and an example brain emulation subnetwork 330.

As described above, the connectivity neural network layers 310 and 340 immediately precede and follow, respectively, the brain emulation subnetwork 330 in the network architecture of a neural network. The neural network can be configured to process manufacturing image data that has been captured by one or more cameras and that represents a manufactured article to generate a prediction of whether the manufactured article has a defect.

In some implementations, the brain emulation subnetwork 330 can be at a location in the network architecture after an encoder subnetwork of the neural network and before a decoder subnetwork of the neural network. As a particular example, the brain emulation subnetwork 330 can be the brain emulation subnetwork 130 described above with reference to FIG. 1B. Generally, the brain emulation subnetwork 330 can be at any appropriate location in the network architecture of the neural network, e.g., before an encoder subnetwork of the neural network, after a decoder subnetwork of the neural network, in a “flat” portion of the network architecture (i.e., a portion of the network architecture where the size of the hidden representations of the network input to the neural network stays constant), and so on.

The block 300 of neural network layers is configured to receive as input encoded manufacturing image data 302, which has been generated by one or more non-biological neural network layers preceding the block 300 in the network architecture of the neural network by processing the manufacturing image data. In some implementations, the encoded manufacturing image data 302 is the same as the manufacturing image data; that is, the block 300 of neural network layers can be configured to process the manufacturing image data directly.

Before processing the encoded manufacturing image data 302 using the input connectivity neural network layer 310, the neural network divides the encoded manufacturing image data 302 into N different input channels 304a-n, N>1. Although the encoded manufacturing image data 302 is depicted as three-dimensional in FIG. 3, generally the input to the block 300 can have any dimensionality. Generally, each element of the encoded manufacturing image data 302 can be included in exactly one input channel 304a-n.

In some implementations, each input channel 304a-n has a lower dimensionality than the encoded manufacturing image data 302. For example, each input channel 304a-n can correspond to a respective different index along a particular dimension of the encoded manufacturing image data 302, and includes every element of the encoded manufacturing image data 302 having the respective index in the particular dimension. As a particular example, if the encoded manufacturing image data 302 has size L₁×W₁, then the neural network can divide the encoded manufacturing image data into L₁ input channels 304a-n (i.e., N=L₁), where each input channel has size W₁. As another particular example, if the encoded manufacturing image data 302 has size L₁×W₁×H₁, then the neural network can divide the encoded manufacturing image data into H₁ input channels 304a-n (i.e., N=H₁), where each input channel 304a-n has size L₁×W₁.

In some other implementations, each input channel 304a-n has the same dimensionality as the encoded manufacturing image data 302. For example, if the encoded manufacturing image data 302 is two-dimensional having size 100×100, then the neural network can divide the encoded manufacturing image data into 100 input channels 304a-n each having size 10×10. As another example, if the encoded manufacturing image data 302 is three-dimensional having size 100×100×100, then the neural network can divide the encoded manufacturing image data into 1000 input channels 304a-n each having size 10×10×10.

Before training the neural network, a training system can randomly assign each position of the encoded manufacturing image data 302 to one or more respective input channels 304a-n . Then, each time the neural network is executed, the neural network can assign the element at each position to the one or more input channels 304a-n corresponding to the position. That is, in some implementations, each element in the encoded manufacturing image data 302 is included in exactly one input channel 304a-n, while in some other implementations, some or all of the elements in the encoded manufacturing image data 302 are included in more than one input channel 304a-n.

For example, the input channels 304a-n can “overlap” each other within the encoded manufacturing image data 302. As a particular example, if the encoded manufacturing image data 302 is a one-dimensional input having ten elements, then the encoded manufacturing image data 302 can be divided into four input channels 304a-n each having four elements, where elements 1-4 are assigned to the first input channel, elements 3-6 are assigned to the second input channel, elements 5-8 are assigned to the third input channel, and elements 7-10 are assigned to the fourth input channel.

In some implementations, each of the input channel 304a-n has the same size. In some other implementations, different input channels 304a-n can have different sizes.

The input connectivity neural network layer 310 includes M different sub-layers 320a-n that are each configured to process a respective proper subset of the input channels 304a-n and to generate a respective updated channel 312a-m. That is, each input connectivity sub-layer 320a-m includes a subset of the parameters of the input connectivity layer 310, and uses the subset of the parameters to process the respective proper subset of input channels 304a-n to generate the respective updated channel 312a-m.

In some implementations, each of the updated channel 312a-m has the same size. In some other implementations, different input channels 312a-m can have different sizes.

Thus, the input connectivity neural network layer 310 is configured to process N input channels 304a-n and generate Mupdated channels 312a-m. In some implementations, M=N. For example, each input connectivity sub-layer 320a-m can be configured to process exactly one input channel 304a-n to generate the corresponding updated channel 312a-m, where each input channel 304a-n is processed by exactly one input connectivity sub-layer 320a-m. In some other implementations, M>N, such that at least one input channel 304a-n is processed by multiple different input connectivity sub-layers 320a-m. In some other implementations, N>M, such that at least one input connectivity sub-layer 320a-mis configured to process multiple different input channels 304a-n.

In some implementations, each input connectivity sub-layer is configured to process the same number of input channels 304a-n . In some other implementations, different input connectivity sub-layers can be configured to process a different number of input channels 304a-n . For example, the first input connectivity sub0layer 320a is configured to process one input channel 304a, while the Mth input connectivity sub-layer 320m is configured to process two input channels 304a and 304n.

In some implementations, each input channel 304a-n is processed by the same number of input connectivity sub-layers 320a-m. In some other implementations, different input channels 304a-n are processed by a different number of input connectivity sub-layers 320a-m. For example, the first input channel 304a is processed by one input connectivity sub-layer 320a, while the N^{th} input channel 304n is processed by two input connectivity sub-layers 320a and 320m.

In some implementations, for each input connectivity sub-layer 320a-m, the size of the updated channel 312a-m generated by the sub-layer is the same as the size of the input channels 304a-n processed by the sub-layer. In some other implementations (e.g., as depicted in FIG. 3), the size of the updated channel 312a-m generated by the sub-layer has a different size than the input channels 304a-n processed by the sub-layer. For example, the updated channel 312a-m generated by the sub-layer can have the same dimensionality as the input channels 304a-n processed by the sub-layer while having more or fewer parameters. As another example, the updated channel 312a-m generated by the sub-layer can have a different dimensionality than the input channels 304a-n processed by the sub-layer.

Each input connectivity sub-layer 320a-n can use any appropriate architecture to generate the respective updated channel 312a-m.

For example, each input connectivity sub-layer 320a-m can be a fully-connected neural network layer. In this example, dividing the encoded manufacturing image data 302 into the input channels 304a-n can still improve the efficiency of the connectivity neural network layer 310 compared to processed the full encoded manufacturing image data 302 using a fully-connected neural network layer. As an illustrative example, if N=M, and if each input channel 304a-n has size L₁×W₁ and each updated channel has size L₂×W₂, then the number of parameters of the input connectivity neural network layer 310 is N·(L₁·W₁)·(L₂·W₂). If the input connectivity neural network layer 310 were a fully-connected neural network layer, then the number of parameters would be (L₁·W₁·N)·(L₂·W₂·N). Thus, dividing the encoded manufacturing image data 302 into the input channels 304a-n improves the efficiency of the input connectivity neural network layer 310 by a factor of N.

As another example, each updated channel 312a-m can be a linear combination of the corresponding input channels 304a-n . That is, each input connectivity sub-layer 320a-m can generate its respective updated channel 312a-m by determining a weighted sum of its respective input channels 304a-n . As an illustrative example, if each sub-layer 320a-m processes k input channels 304a-n, then the input connectivity neural network layer 310 only has k·M learned parameters, a significant efficiency improvement over the case, described above, where the input connectivity neural network layer 310 is a fully-connected layer.

As another example, each input connectivity sub-layer can process the corresponding proper subset of input channels 304a-n using a convolutional kernel.

The brain emulation subnetwork 330 is configured to process the updated channels 312a-m and to generate P brain emulation channels 332a-p, P>1. As described above, the parameters of the brain emulation subnetwork 330 can be determined using biological connectivity between neuronal elements in the brain of a biological organism. In some implementations, P=M. In some other implementations, P>M. In some other implementations, P<M.

In some implementations, each of the brain emulation channels 332a-p has the same size. In some other implementations, different brain emulation channels 332a-p can have different sizes.

In some implementations, the brain emulation subnetwork 330 does not process the updated channels 312a-m independently. Rather, the brain emulation subnetwork 330 can combine the updated channels 312a-m into a single brain emulation subnetwork input, and process the brain emulation subnetwork input to generate the brain emulation channels 332a-p.

In some implementations, the output of the brain emulation subnetwork 330 is not explicitly divided into the P brain emulation channels 332a-p. That is, the brain emulation subnetwork 330 can be configured to generate a single brain emulation output, and the neural network can then divide the brain emulation output into the brain emulation channels 332a-p. For example, the neural network can divide the brain emulation output in any way described above with reference to dividing the encoded manufacturing image data 302.

In some implementations, the architecture of the brain emulation subnetwork 330 is represented using a weight matrix, where each element of the weight matrix is a respective parameter of the brain emulation subnetwork 330. Each element of the weight matrix can correspond to a pair of neuronal elements in the brain of the biological organism, where the value of the element characterizes a strength of a biological connection between the pair of neuronal elements. In other words, each row and column of the weight matrix can correspond to a respective neuronal element in the brain of the biological organism, and the value of each element characterizes a strength of a biological connection between (i) the neuronal element corresponding to the row of the element and (ii) the neuronal element corresponding to the column of the element. The process of generating the weight matrix is described in more detail below.

For example, the weight matrix of the brain emulation subnetwork 330 can have size M×P, such that the size of the brain emulation channels 332a-p is the same as the size of the updated channels 312a-m. In other words, each brain emulation channel 332a-p can be a linear combination of the updated channels 312a-m, where the linear combination corresponding to brain emulation channel 332i is defined by the ith column of the weight matrix.

As another example, the brain emulation subnetwork 330 can be a fully-connected neural network layer. As an illustrative example, if the updated channels 312a-m have size L₂×W₂ and the brain emulation channels 332a-p have size L₃×W₃, then the weight matrix of the brain emulation subnetwork 330 has size (M·L₂·W₂)×(P·L₃·W₃). In some implementations, the weight matrix is a square matrix where the same neuronal elements in the brain of the biological organism are represented by both the rows and the columns of the weight matrix.

The output connectivity neural network layer 340 is configured to process the brain emulation channels 332a-p to generate Q output channels 352a-q, Q>1. The output connectivity neural network layer 340 can be configured similarly to the input connectivity layer 310. The output connectivity neural network layer 340 can have any of the configurations described above with reference to the input connectivity layer 310. In particular, the output connectivity neural network layer 340 can include Q output connectivity sub-layers 350a-q that are each configured to process a respective proper subset of the brain emulation channels 332a-p to generate a respective output channel 352a-q.

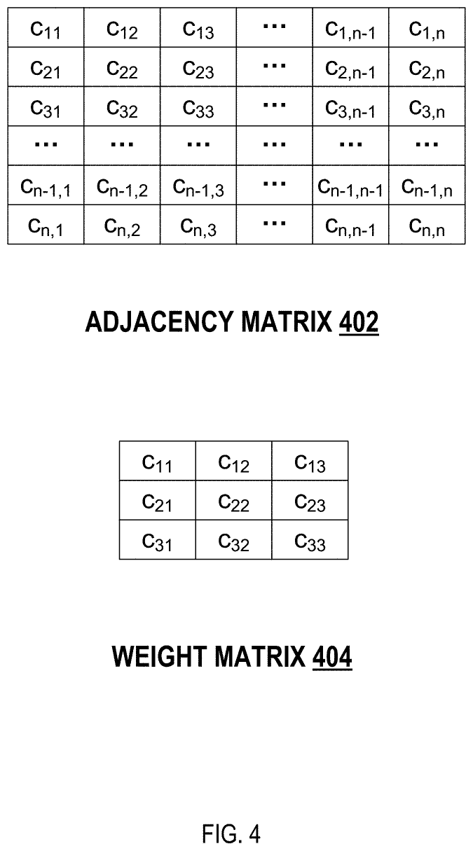

The neural network can process the output channels 352a-q using one or more subsequent non-biological neural network layers of the neural network to generate a network output for the neural network, i.e., to predict whether the manufactured article represented by the manufacturing image data has a defect. FIG. 4 illustrates an example weight matrix 404 of a brain emulation neural network layer determined using biological connectivity

As described in more detail below with reference to FIG. 7, a system (e.g., the graphing system 712 depicted in FIG. 7), can generate a synaptic connectivity graph that represents the biological connectivity between neuronal elements in the brain of the biological organism. The synaptic connectivity graph can be represented using an adjacency matrix 402, all of which or a portion of which can be used as the weight matrix 404 of the brain emulation neural network layer.

As illustrated in FIG. 4, the adjacency matrix 402 includes n² elements, where n is the number of neuronal elements drawn from the brain of the biological organism. For example, the adjacency matrix 402 can include hundreds, thousands, tens of thousands, hundreds of thousands, millions, tens of millions, or hundreds of millions of elements.

Each element of the adjacency matrix 402 represents the biological connectivity between a respective pair of neuronal elements in the set of n neuronal elements. That is, each element c_{i,j} identifies the biological connection between neuronal element i and neuronal element j. As described in more detail below, in some implementations, each of the elements c_{i,j} are either zero (representing that there is no biological connection between the corresponding neuronal elements) or one (representing that there is a biological connection between the corresponding neuronal elements), while in some other implementations, each element c_{i,j} is a scalar value representing the strength of the biological connection between the corresponding neuronal elements. Each row and each column of the adjacency matrix 402 can represent a respective neuronal element in the brain of the biological organism. In particular, each row of the adjacency matrix 402 can represent a respective neuronal element in a first set of neuronal elements of the brain of the biological organism, and each column of the adjacency matrix 402 can represent a respective neuronal element in a second set of neuronal elements of the brain of the biological organism. Generally, the first set and the second set can be overlapping or disjoint. As a particular example, the first set and the second set can be the same.

In some implementations (e.g., in implementations in which the synaptic connectivity graph is undirected), the adjacency matrix 402 is symmetric (i.e., each element c_{i,j} is the same as element while in some other implementations (e.g., in implementations in which the synaptic connectivity graph is directed), the adjacency matrix 402 is not symmetric (i.e., there may exist elements c_{i,j} and c_{j,i} such that cᵢⱼ≠c_{j,i}).

Although the above description refers to neuronal elements in the brain of the biological organism, generally the elements of the adjacency matrix can correspond to pairs of any appropriate component of the brain of the biological organism. For example, each element can correspond to a pair of voxels in a voxel grid of the brain of the biological organism.

As described in more detail below with reference to FIG. 7, an architecture mapping system (e.g., the architecture mapping system 720 depicted in FIG. 7) can generate the weight matrix 404 from the adjacency matrix 402. Generally, the elements of the weight matrix 404 (i.e., the brain emulation parameters of the brain emulation neural network layer) are a subset of the elements of the adjacency matrix 402. For example, as depicted in FIG. 4, the weight matrix 404 includes the elements of the adjacency matrix 402 representing biological connections between the neuronal elements represented by the first three rows and first three columns of the adjacency matrix 402. For example, the weight matrix 404 can represent only neuronal elements of a particular type in the brain of the biological organism. Identifying neuronal elements of a particular type is discussed in more detail below with reference to FIG. 8.

For convenience, the weight matrix 404 is illustrated as including only nine brain emulation parameters; generally, weight matrices of brain emulation neural network layers can have significantly more brain emulation parameters, e.g., hundreds, thousands, or millions of brain emulation parameters. Although the weight matrix 404 is depicted as square in FIG. 4 (i.e., the same number of columns and rows), generally the weight matrix 404 can have any appropriate dimensionality.

That is, generally the weight matrix 404 can be an M×N matrix, where each of the M rows corresponds to a neuronal element in a first set of neuronal elements and each of the N columns corresponds to a neuronal element in a second set of neuronal elements in the brain of the biological organism. The first set of neuronal elements and the second set of neuronal elements can be overlapping (i.e., one or more neuronal elements in the brain of the biological organism is in both sets) or disjoint (i.e., there does not exist a neuronal element in the brain of the biological organism that is in both sets). As a particular example, the first set and the second set can be the same. That is, the weight matrix 404 can be an N×N matrix where the same neuronal elements in the brain of the biological organism are represented by both the rows and the columns of the weight matrix. The process of generating the weight matrix is described in more detail below.

In some implementations, the weight matrix 404 represents the entire synaptic connectivity graph. That is, the weight matrix 404 can include a respective row and column for each node of the synaptic connectivity graph. The weight matrix 404 can be a sparse matrix, i.e., can include more than a threshold number or proportion of zero-value brain emulation parameters.

FIG. 5 shows an example neural network training system 500. The neural network computing system 500 is an example of a system implemented as computer programs on one or more computers in one or more locations in which the systems, components, and techniques described below are implemented.

The neural network computing system 500 includes a neural network 502 that has (at least) three subnetworks: (i) a first non-biological subnetwork 504 (ii) a brain emulation subnetwork 508, and (iii) a second non-biological subnetwork 512. The neural network 502 is configured to process manufacturing image data 501 representing a manufactured article, and to generate a network output 514 that represents a prediction of whether the manufactured article is defective.

The first non-biological subnetwork 504 is configured to process the manufacturing image data 501 in accordance with a set of model parameters 522 of the first non-biological subnetwork 504 to generate a first subnetwork output 506. The final neural network layer of the first non-biological subnetwork 504 can be a connectivity neural network layer, e.g., the input connectivity neural network layer 120 depicted in FIG. 1B.

The brain emulation subnetwork 508 is configured to process the first subnetwork output 506 in accordance with a set of model parameters 524 of the brain emulation subnetwork 508 to generate a brain emulation subnetwork output 510. In this specification, the parameters of a brain emulation subnetwork or brain emulation neural network layer are also called “brain emulation parameters.”

The second non-biological subnetwork 512 is configured to process the brain emulation subnetwork output 510 in accordance with a set of model parameters 526 of the second non-biological subnetwork 512 to generate the network output 514. The first neural network layer of the second non-biological subnetwork 512 can be a connectivity neural network layer, e.g., the output connectivity neural network layer 140 depicted in FIG. 1B.

The brain emulation subnetwork can include one or more brain emulation neural network layers whose respective architectures have been determined using biological connectivity. For example, the brain emulation subnetwork 508 can be configured similarly to the brain emulation subnetwork 130 described above with reference to FIG. 1B.

Although the neural network 502 depicted in FIG. 5 includes one non-biological subnetwork 504 before the brain emulation subnetwork 508 and one non-biological subnetwork 512 after the brain emulation subnetwork 508, in general the neural network 502 can include any number of non-biological subnetworks before and/or after the brain emulation subnetwork 508. In some implementations, the first non-biological subnetwork 504 and/or the second non-biological subnetwork 512 can include only one or a few neural network layers (e.g., a single fully-connected layer) that processes the respective subnetwork input to generate the respective subnetwork output.

In implementations where there are zero non-biological subnetworks before the brain emulation subnetwork 508, the brain emulation subnetwork 508 can receive the manufacturing image data 501 directly as input. In implementations where there are zero non-biological subnetworks after the brain emulation subnetwork 508, the brain emulation subnetwork output 510 can be the network output 514.

Although the neural network 502 depicted in FIG. 5 includes a single brain emulation subnetwork 508, in general the neural network 502 can include multiple brain emulation subnetwork 508. In some implementations, each brain emulation subnetwork 508 has the same set of brain emulation parameters 524; in some other implementations, each brain emulation subnetwork 508 has a different set of brain emulation parameters 524. In some implementations, each brain emulation subnetwork 508 has the same network architecture; in some other implementations, each brain emulation subnetwork 508 has a different network architecture.

In some implementations, the brain emulation subnetwork 508 has a recurrent neural network architecture. That is, the brain emulation subnetwork 508 can process the first subnetwork output 506 multiple times at respective time steps.

For example, the architecture of the brain emulation subnetwork 508 can include a sequence of components (e.g., brain emulation neural network layers or groups of brain emulation neural network layers) such that the architecture includes a connection from each component in the sequence to the next component, and the first and last components of the sequence are identical. In one example, two brain emulation neural network layers that are each directly connected to one another (i.e., where the first layer provides its output the second layer, and the second layer provides its output to the first layer) would form a recurrent loop. A recurrent brain emulation subnetwork 508 can process the first subnetwork output 506 over multiple time steps to generate a respective brain emulation subnetwork output 510 at each time step. In particular, at each time step, the brain emulation subnetwork 508 can process: (i) the first subnetwork output 506 (or a component of the first subnetwork output 506), and (ii) any outputs generated by the brain emulation subnetwork 508 at the preceding time step, to generate the brain emulation subnetwork output 510 for the time step. The neural network 502 can provide the brain emulation subnetwork output 510 generated by the brain emulation subnetwork 508 at the final time step as the input to the second non-biological subnetwork 512. The number of time steps over which the brain emulation subnetwork 508 processes the first subnetwork output 506 can be a predetermined hyper-parameter of the neural network computing system 500.

In some implementations, in addition to processing the brain emulation subnetwork output 510 generated by the output layer of the brain emulation subnetwork 508, the second non-biological subnetwork 512 can additionally process one or more intermediate outputs of the brain emulation subnetwork 508.

The neural network computing system 500 includes a training engine 516 that is configured to train the neural network 502.

In some implementations, the brain emulation parameters 524 for the brain emulation subnetwork 508 are untrained. Instead, the brain emulation parameters 524 of the brain emulation subnetwork 508 can be determined before the training of the non-biological subnetworks 504 and 512 based on the weight values of the edges in a synaptic connectivity graph representing biological connectivity between neuronal elements in the brain of a biological organism. Optionally, the weight values of the edges in the synaptic connectivity graph can be transformed (e.g., by additive random noise) prior to being used for specifying brain emulation parameters 524 of the brain emulation subnetwork 508. This procedure enables the neural network 502 to take advantage of the information from the synaptic connectivity graph encoded into the brain emulation subnetwork 508.

Therefore, rather than training the entire neural network 502 from end-to-end, the training engine 516 can train only the model parameters 522 of the first non-biological subnetwork 504 and the brain emulation parameters 526 of the second non-biological subnetwork 512, while leaving the brain emulation parameters 524 of the brain emulation subnetwork 508 fixed during training.

The training engine 516 can train the neural network 502 on a set of training data over one or more training iterations. The training data can include a set of training examples, where each training example specifies: (i) a training input that includes or has been generated from manufacturing image data 501 representing a respective manufactured article, and (ii) a target network output that should be generated by the neural network 502 by processing the training network input, i.e., a target network output identifying whether or not the manufactured article represented by the training input actually has a defect. In some implementations, the target network outputs are human-labeled target outputs, e.g., where a user has inspected the manufacturing image data to determine whether the manufacturing image data depicts a defect. In some implementations, each training input has been generated from manufacturing image data representing the same type of manufactured article; in some other implementations, different training inputs have been generated from manufacturing image data representing respective different types of manufactured article.

In some implementations, only a single training iteration is required for the neural network 502 to achieve a high performance, significantly reducing the time, computational cost, and monetary cost of training the neural network relative to some existing techniques. For example, if the neural network 502 would have required a thousand training iterations to achieve a comparable performance if the neural network 502 did not include the brain emulation subnetwork 508, then the cost of training (e.g., as measured by the monetary cost of running the hardware used during training, e.g., one or more graphics processing unit (GPUs) or one or more tensor processing units (TPUs)) is reduced by 1000× by adding the brain emulation subnetwork 508 to the network architecture.

In some implementations, training examples for training the neural network 502 can be scarce. As described above, manually labeling manufacturing image data can be a time-intensive and expensive process, such that less than a hundred, less than a thousand, or less than ten thousand training examples are available for training the neural network 502 (whereas for some other machine learning tasks, hundreds of thousands, millions, or tens of millions of training examples may be available). Positive training example (i.e., training examples that represent manufactured articles that do have a defect) may be scarcer still. By including the brain emulation subnetwork 508 (the parameters for which, in some implementations, do not need to be trained) in the network architecture of the neural network 502 can allow the neural network training system 500 to train the neural network 502 to achieve a high performance even in cases where training data is scarce.

In some implementations, the neural network training system 500 (or an external system) can augment the training data by generating multiple different updated training examples for each initial training example in a set of initial training examples. For example, given an initial training example, the neural network training system 500 can generate an updated training example by processing the training input of the initial training example using one or more operations, e.g., a rotation operation, a flipping operation, a scaling operation, a cropping operation, a translation operation, a blurring operation, or an operation to add randomly-sampled noise to the initial training example. As another example, given an initial training example, the neural network training system 500 can “tile” the manufacturing image data 501 of the training input of the initial training example, i.e., breaking the manufacturing image data 501 into multiple sub-images such that each sub-image represents the training input for an updated training example. Generally, the target network output of each updated training example is the same as the target network output of the corresponding initial training example.

In some such implementations, to overcome the relative scarcity of positive training examples (i.e., where the corresponding manufactured article has a defect) relative to negative training examples (i.e., where the corresponding manufactured article does not have a defect), the neural network training system 500 can generate additional positive updated training examples, e.g., as described above. Instead or in addition, when performing a training iteration, the training engine 516 can sample more positive training example than negative training example to process using the neural network 502.

At each training iteration, the training engine 516 can sample a batch of training examples from the training data, and process the training inputs specified by the training examples using the neural network 502 to generate corresponding network outputs 514. In particular, for each training input, the neural network 502 processes the training input using the current model parameter values 522 of the first non-biological subnetwork 504 to generate a first subnetwork output 506. The neural network 502 processes the first subnetwork output 506 in accordance with the static brain emulation parameters 524 of the brain emulation subnetwork 508 to generate a brain emulation subnetwork output 510. The neural network 502 then processes the brain emulation subnetwork output 510 using the current model parameter values 526 of the second non-biological subnetwork 512 to generate the network output 514 corresponding to the training input.

The training engine 516 adjusts the model parameters values 522 of the first non-biological subnetwork 504 and the model parameter values 526 of the second non-biological subnetwork 512 to optimize an objective function that measures a similarity between: (i) the network outputs 514 generated by the neural network 502, and (ii) the target network outputs specified by the training examples.

For example, the training engine 516 can use an objective function that penalizes false negative predictions more than false positive predictions.

In this specification, a false negative prediction is a prediction, generated by a neural network in response to processing a network input representing a manufactured article, that incorrectly predicts the lack of a defect. For example, if the neural network generates a network output that predicts the manufactured article as a whole does not have a defect when the manufactured article does have a defect, then the network output is a false negative. As another example, if the neural network generates a network output that includes a prediction that a particular element (e.g., a particular pixel) of the network input does not represent a defect when the particular element does represent a defect, then the prediction about the particular element is a false negative (e.g., in implementations in which the neural network generates a semantic segmentation of the network input).

In this specification, a false positive prediction is a prediction, generated by a neural network in response to processing a network input representing a manufactured article, that incorrectly predicts the presence of a defect. For example, if the neural network generates a network output that predicts the manufactured article as a whole does have a defect when the manufactured article does not have a defect, then the network output is a false positive. As another example, if the neural network generates a network output that includes a prediction that a particular element (e.g., a particular pixel) of the network input does represent a defect when the particular element does not represent a defect, then the prediction about the particular element is a false positive (e.g., in implementations in which the neural network generates a semantic segmentation of the network input).

When performing defect detection, predicting a false negatives can be more harmful than predicting a false positive. For example, in implementations in which manufactured articles predicted to be defective are flagged for further inspection, then in the case of a false positive, the user or system performing the inspection can determine that the manufactured product is not defective and allow the manufactured article to continue in the manufacturing pipeline (e.g., allow the manufactured article to be sold to a consumer). However, in the case of a false negative, a defective product may be released and sold to a consumer, which can be unsafe.

As a particular example, the training engine 516 can train the neural network 502 using a binary focal loss function. For example, the training engine 516 can compute the following binary focal loss:

$$FL ( {p}_{t} ) = - {{α}_{t} ( 1 - {p}_{t} )}^{γ} log ( {p}_{t} )$$

$$where$$

$${p}_{t} = \{ \begin{matrix}p & if y = 1 \\ 1 - p & otherwise\end{matrix}$$

$${α}_{t} = \{ \begin{matrix}α & if y = 1 \\ 1 - α & otherwise\end{matrix}$$

wherein p is the predicted likelihood that the network input (or an element thereof) represents a defect, y is the target output for the prediction p (where y=1 indicates that a defect is present), and γ and α are hyperparameters of the training engine 516. In some implementations, the αₜ term is not included in the binary focal loss computation.

The binary focal loss function can be particularly effective when the training data is imbalanced, e.g., when there are relatively few positive training examples and/or relatively few elements (e.g., pixels) of the positive training examples actually represent a defect, as described above.

To name a few other examples, the objective function can be a cross-entropy objective function, a squared-error objective function, or any other appropriate objective function.

To optimize the objective function, the training engine 516 can determine gradients of the objective function with respect to the model parameters 522 of the first non-biological subnetwork 504 and the model parameters 526 of the second non-biological subnetwork 512, e.g., using backpropagation techniques. The training engine 516 can then use the gradients to adjust the model parameter values 522 and 526, e.g., using any appropriate gradient descent optimization technique, e.g.., an RMSprop or Adam gradient descent optimization technique.

The training engine 516 can use any of a variety of regularization techniques during training of the neural network 502. For example, the training engine 516 can use a dropout regularization technique, such that certain artificial neurons of the neural network 502 are “dropped out” (e.g., by having their output set to zero) with a non-zero probability p>0 each time the neural network 502 processes a network input. Using the dropout regularization technique can improve the performance of the trained neural network 502, e.g., by reducing the likelihood of over-fitting. As another example, the training engine 516 can regularize the training of the neural network 502 by including a “penalty” term in the objective function that measures the magnitude of the model parameter values 522 and 526 of the non-biological subnetworks 504 and 512. The penalty term can be, e.g., an Li or L2 norm of the model parameter values 522 of the first non-biological subnetwork 504 and/or the model parameter values 526 of the second non-biological subnetwork 512.

In some other implementations, the brain emulation parameters 524 for the brain emulation subnetwork 508 are trained. That is, after initial values for the brain emulation parameters 524 of the brain emulation subnetwork 508 have been determined based on the weight values of the edges in the synaptic connectivity graph, the training engine 516 can update the weights of the brain emulation parameters, as described above with reference to the parameters 522 and 526 of the non-biological subnetworks, e.g., using backpropagation and stochastic gradient descent.

In some implementations, the some or all of the brain emulation parameters 524 (e.g., the brain emulation parameters for a particular brain emulation neural network layer of the brain emulation subnetwork 508) are represented by a sparse weight matrix. In this specification, a matrix may be referred to as a “sparse matrix” if the sparsity of the matrix (i.e., the number or proportion of zero-value elements of the matrix) satisfies a certain threshold. For example, in some implementations the weight matrix of a brain emulation neural network layer has a sparsity of 50% (i.e., where 50% of the brain emulation parameters of the weight matrix have a value of zero), 60%, 70%, 80%, 90%, 95%, or 99%.

In some such implementations, when updating the brain emulation parameters of a sparse weight matrix, the training engine 516 keeps the zero-value elements of the sparse weight matrix constant, i.e., at zero. If the training engine 516 executed backpropagation and gradient descent across all the values of the weight matrix, zero-value brain emulation parameters of the weight matrix would likely be updated to non-zero values. Because the weight matrix represents biological connectivity between neuronal elements in the brain of a biological organism, updating a zero-value brain emulation parameter to have a non-zero value corresponds to incorrectly representing biological connectivity between the pair of neuronal elements represented by the brain emulation parameter, when no such biological connectivity was measured in the brain of the biological organism. Thus, in some implementations in which fidelity to the measured biological connectivity is important, the training engine 516 avoids inserting representations of new and incorrect biological connections by freezing the zero-value brain emulation parameters at zero.

In some other such implementations, the training engine 516 does update some or all of the zero-value brain emulation parameters of the weight matrix to have a non-zero value. Instead or in addition, the training engine 516 can update one or more non-zero brain emulation parameters of the weight matrix to have a value zero, and freeze the value at zero.

For example, the training engine 516 can execute an artificial evolutionary procedure whereby, over multiple training stages, the training engine 516 iteratively removes the brain emulation parameters representing the weakest biological connections in the brain of the biological organism from the weight matrix. The training engine 516 can also add new brain emulation parameters to the weight matrix, where the new brain emulation parameters represent “new” biological connections in the brain of the biological organism (i.e., biological connections that were not measured in the brain of the biological organism).

This procedure is referred to as “evolutionary” because it simulates, across the multiple training stages, the removal of “weak” brain emulation parameters (e.g., brain emulation parameters with the lowest value or magnitude) and the addition of new brain emulation parameters that may improve the performance of the neural network 502. Performing the evolutionary procedure can further reduce the amount of training data and the number of training iterations required to train the neural network 502 to achieve an acceptable level of performance, e.g., as measured by prediction accuracy.

For example, at each of one or more training stages during the training of the neural network 502, the training engine 516 can stochastically sample (i.e., select) non-zero brain emulation parameters of the weight matrix, and remove the sampled non-zero brain emulation parameters from the weight matrix.

As a particular example, the training engine 516 can sample each non-zero brain emulation parameter with a uniform likelihood. That is, each non-zero brain emulation parameter can have the same likelihood of being selected, regardless of the value of the parameter or the position of the parameter within the weight matrix. As another particular example, the training engine 516 can determine the N non-zero brain emulation parameters that have the lowest respective magnitudes, N>1, and sample the N non-zero brain emulation parameters uniformly. For instance, N can be a predetermined integer, or N can be a predetermined fraction of the total number of non-zero brain emulation parameters in the weight matrix.

As another particular example, the training engine 516 can sample each non-zero brain emulation parameter with a likelihood that is inversely proportional with the magnitude of its value. That is, non-zero brain emulation parameters with lower magnitudes can be more likely to be selected than non-zero brain emulation parameters with higher magnitudes.

In some such implementations, the training engine 516 can determine the likelihood of sampling each non-zero brain emulation parameter to be equal to the softmax of the negated magnitude of the non-zero brain emulation parameter. That is, the training engine 516 can compute:

$${p}_{i} = \frac{{e}^{- \vert {x}_{i} \vert}}{{Σ}_{j} {e}^{- \vert {x}_{j} \vert}}$$

where xi is the value of the i^{th} non-zero brain emulation parameter and pᵢ is the likelihood with which the i^{th} non-zero brain emulation parameter is sampled by the training engine 516.

In some other such implementations, the training engine 516 can determine the likelihood of sampling each non-zero brain emulation parameter to be equal to the softmax of the inverse magnitude of the non-zero brain emulation parameter. That is, the training engine 516 can compute:

$${p}_{i} = \frac{{e}^{1 / \vert {x}_{i} \vert}}{{Σ}_{j} {e}^{1 / \vert {x}_{j} \vert}}$$

In some other such implementations, the training engine 516 can determine the N non-zero brain emulation parameters that have the lowest respective magnitudes, N>1, and sample the N non-zero brain emulation parameters according to either of the softmax equations described above.

As another particular example, the training engine 516 can sample each represented brain emulation parameter with a likelihood that is inversely proportional to the rank of the non-zero brain emulation parameter in a ranking of the non-zero brain emulation parameters of the weight matrix. That is, non-zero brain emulation parameters with lower ranks in the ranking of the magnitudes can be more likely to be selected than non-zero brain parameters with higher ranks in the ranking of the magnitudes. In some such implementations, the training engine 516 can determine the N non-zero brain emulation parameters that have the lowest respective ranks in the ranking of the magnitudes, N>1, and sample the N non-zero brain emulation parameters according to their respective ranks.

As another example, the training engine 516 can execute a two-step process for stochastically sampling the non-zero brain emulation parameters of the weight matrix. In the first step of the two-step process, the training engine 516 can generate a set of candidate non-zero brain emulation parameters by sampling the non-zero brain emulation parameters according to a ranking of their magnitudes. In the second step of the two-step process, the training engine 516 can sample from the set of non-zero brain emulation parameters according to their magnitudes (e.g., using a softmax function as described above). The training engine 516 can then remove the candidate non-zero brain emulation parameters sampled in the second step from the weight matrix.

In some implementations, the training engine 516 removes the same number of non-zero brain emulation parameters at each training stage. In some other implementations, the training engine 516 can sample a different number of non-zero brain emulation parameters at each training stage.

Instead of or in addition to removing non-zero brain emulation parameters from the compressed matrix representation, the training engine 516 can add “new” non-zero brain emulation parameters to the weight matrix at each of one or more training stages. For example, the training engine 516 can randomly sample one or more zero-value brain emulation parameters of the weight matrix, generate values for the sampled zero-value brain emulation parameters, and insert the sampled zero-value brain emulation parameters, having the respective generated values, into the weight matrix as newly-non-zero brain emulation parameters.

For example, the training engine 516 can sample a respective value for each new non-zero brain emulation parameter from a predefined distribution, e.g., a uniform distribution between 0 and 1 or a Normal distribution with mean 0.

As another example, the training engine 516 can determine the initial value of the new non-zero brain emulation parameters to be 0. Then, during training of the neural network 502, the value of these new non-zero brain emulation parameters can be updated to actually have non-zero values, e.g., using stochastic gradient descent.

In some implementations, the training engine 516 samples the same number of zero-value brain emulation parameters as the number of non-zero value brain emulation parameters sampled as described above. That is, the weight matrix can include the same number of non-zero brain emulation parameters before and after the training stage. In some other implementations, the training engine 516 samples a different number of non-zero and zero-value brain emulation parameters during a given training stage, such that the number of non-zero brain emulation parameters in the weight matrix changes.

In some implementations, the training engine 516 can sample new non-zero brain emulation parameters to add to the weight matrix such that the sampled new non-zero brain emulation parameters are biologically plausible. That is, the training engine 516 can ensure that each new non-zero brain emulation parameter represents a pair of neuronal elements that could plausibly share a biological connection in the brain of the biological organism. For example, the training engine 516 can sample new non-zero brain emulation parameters corresponding to pairs of neuronal elements in the same region of the brain of the biological organism.

In some implementations, the training engine 516 trains multiple different versions of the neural network 502, e.g., using respective different hyper-parameter values for a set of hyper-parameters of the neural network 502. The training engine 516 can then select the version of the neural network 502 that has the highest performance (e.g., as measured by prediction accuracy) for deployment. As described above, the presence of the brain emulation subnetwork 508 can significantly reduce the amount of time required to train a version of the neural network. For example, while some existing techniques require that a neural network be trained over hundreds of thousands or millions of training steps, the inclusion of the brain emulation neural network 508 can allow the neural network 102 to be trained in merely 10, 50, 100, or 500 training steps. Therefore, inserting the brain emulation subnetwork 508 into the network architecture of the neural network 502 can allow the training engine 516 to train many more different versions of the neural network 502 using a constant computational budget. Therefore, the training engine 516 can do a more exhaustive search of the space of hyper-parameter values in a reduced amount of time, providing the opportunity for the training engine 516 to train superior versions of the neural network 502 than if the neural network 502 did not include the brain emulation subnetwork 508.

In some implementations, the training engine 516 trains the neural network 502 to perform multiple different machine learning tasks using the manufacturing image data 501. For example, the neural network 502 can include multiple “head” subnetworks (e.g., head subnetworks of the second non-biological subnetwork 512) that each correspond to a respective machine learning task. Each head subnetwork can process a hidden representation of the manufacturing image data 501 (e.g., each head subnetwork can process the same hidden representation generated by a preceding neural network layer of the second non-biological subnetwork 512) and generate a prediction corresponding to the respective machine learning task. The network output 514 can then include each prediction generated by a respective head subnetwork. As a particular example, each head subnetwork can include only one or a few non-biological neural network layers, e.g., feedforward neural network layers.

For example, the neural network 502 can be configured to generate multiple different network outputs 514 related to defect detection. For instance, in response to processing manufacturing image data 501 representing a manufactured article, the neural network 502 can generate (i) a first network output 514 that is a semantic segmentation of the manufacturing image data 501 that identifies, for each element of the manufacturing image data 501, whether the element represents a defect (as described above) and (ii) a second network output 514 that is a classification of the manufactured article as a whole as either defective or not defective (as described above). As a particular example, the manufactured article can be determined to be defective if both the first network output and the second network output satisfy one or more conditions. For instance, the manufactured article can be determined to be defective if (i) a first network output representing a semantic segmentation of the manufacturing image data 501 includes a threshold number of pixels that have a score for one or more defect classes exceeding a first threshold, and (ii) a second network output representing a likelihood that a defect is present in the manufactured article represented by the image data 501 exceeds a second threshold.

As another example, the neural network 502 can be configured to generate a network output 514 that includes one or more additional predictions about the manufactured article represented by the manufacturing image data 501, in addition to predicting the presence of defects. That is, defect detection can be considered the “primary” machine learning task of the neural network 502, while the one or more other machine learning tasks can be considered “auxiliary” machine learning tasks. The training engine 516 can train the neural network 502 to perform the auxiliary machine learning tasks in order to improve the performance of the neural network 502 on the primary machine learning task, i.e., the improve the performance of the neural network 502 when identifying defects in the manufacturing image data 501. The auxiliary machine learning tasks can be tasks that complement the task of defect detection. Thus, by updating the model parameters 522 and 526 (and, optionally, the brain emulation parameters 524) according to an error in the predictions for the respective auxiliary machine learning tasks, the training engine 516 can improve the performance of the model parameters 522 and 526 on defect detection. The one or more auxiliary machine learning tasks can be include any appropriate task.

For example, the auxiliary machine learning tasks can include one or more of: prediction a particular region of interest on the manufactured article represented by the manufacturing image data 501, e.g., a region that includes a defect; predicting an orientation of the manufactured article represented by the manufacturing image data 501, e.g., in implementations in which the manufactured article can have multiple different orientations relative to the camera that captured the manufacturing image data 501; predicting a color of the manufactured article represented by the manufacturing image data 501, e.g., in implementations in which the neural network 502 is configured to process manufacturing image data 501 corresponding to a type of manufactured article that has multiple color options; or predicting a type of material included in the manufactured article represented by the manufacturing image data 501, e.g., in implementations in which the neural network 502 is configured to process manufacturing image data 501 corresponding to a type of manufactured article that can be made from multiple different types of material (e.g., clothing that can be made from multiple different types of fabric).

Typically, after the neural network 502 has been trained, the neural network 502 only performs defect detection at inference time. Thus, the neural network 502 can be deployed only with the head subnetwork corresponding to the primary machine learning task; that is, the head subnetworks corresponding to respective auxiliary machine learning tasks can be removed before deployment.

Generally, after training, the neural network 502 can be directly applied to perform defect detection in an inference environment, e.g., directly in the manufacturing environment as described above with reference to FIG. 1A.

In some implementations, after the neural network 502 has been deployed to an inference environment, some or all of the parameters of the neural network 502 can be further trained, i.e., “fine-tuned,” using new training example obtained by in the inference environment. For example, some of the parameters can be fine-tuned using training examples corresponding to the specific inference environment (e.g., specific to attributes of the factory or fabrication plant in which the neural network 502 has been deployed), so that the neural network 502 can achieve a higher accuracy for inputs received in the inference environment. As a particular example, the model parameters 522 of the first non-biological subnetwork 504 and/or the model parameters 526 of the second non-biological subnetwork 512 can be fine-tuned using new training examples while the model parameters 524 of the brain emulation subnetwork 508 are held static, as described above.

FIG. 6 illustrates an example of generating an artificial (i.e., computer implemented) brain emulation neural network 609 based on a synaptic resolution image 605 of the brain 603 of a biological organism 601, e.g., a fly.

The synaptic resolution image 605 can be processed to generate a synaptic connectivity graph 607. The synaptic connectivity graph 607 represents synaptic connectivity between neuronal elements in the brain 603 of the biological organism 601. A “neuronal element” can refer to an individual neuron, a portion of a neuron, a group of neurons, or any other appropriate biological element in the brain 603 of the biological organism 601. As will be described in more detail below with reference to FIG. 8, the synaptic connectivity graph 607 can include multiple nodes and multiple edges, where each edge connects a respective pair of nodes. At least a subset of the nodes of the synaptic connectivity graph 607 can represent respective neuronal elements in the brain 603 of the biological organism, and each edge between pairs of nodes in the subset can represent a biological connection between the pair of neuronal elements corresponding to the pair of nodes. In one example, each node in the graph 108 can represent an individual neuron, and each edge connecting a pair of nodes in the graph 108 can represent a respective synaptic connection between the corresponding pair of individual neurons.

In some implementations, the synaptic connectivity graph 607 can be an “over-segmented” synaptic connectivity graph, e.g., where at least some nodes in the graph represent a portion of a neuron, and at least some edges in the graph connect pairs of nodes that represent respective portions of neurons. In some implementations, the synaptic connectivity graph 607 can be a “contracted” synaptic connectivity graph, e.g., where at least some nodes in the graph represent a group of neurons, and at least some edges in the graph represent respective connections (e.g., nerve fibers) between such groups of neurons. In some implementations, the synaptic connectivity graph 607 can include features of both the “over-segmented” graph and the “contracted” graph. Generally, the synaptic connectivity graph 607 can include nodes and edges that represent any appropriate neuronal element, and any appropriate biological connection between a pair of neuronal elements, respectively, in the brain 603 of the biological organism 601.

The structure of the synaptic connectivity graph 607 can be used to specify the architecture of the brain emulation neural network 609. For example, each node of the graph 607 can be mapped to an artificial neuron, a neural network layer, or a group of neural network layers in the brain emulation neural network 609. Further, each edge of the graph 607 can be mapped to a connection between artificial neurons, layers, or groups of layers in the brain emulation neural network 609. The brain 603 of the biological organism 601 can be adapted by evolutionary pressures to be effective at solving certain tasks, e.g., classifying objects or generating robust object representations, and the brain emulation neural network 609 can share this capacity to effectively solve tasks.

FIG. 7 shows an example data flow 700 for generating a synaptic connectivity graph 702 and a brain emulation neural network 704 based on the brain 706 of a biological organism. As used throughout this document, a brain may refer to any amount of nervous tissue from a nervous system of a biological organism, and nervous tissue may refer to any tissue that includes neurons (i.e., nerve cells). The biological organism can be, e.g., a worm, a fly, a mouse, a cat, or a human.

An imaging system 708 can be used to generate a synaptic resolution image 710 of the brain 706. An image of the brain 706 may be referred to as having synaptic resolution if it has a spatial resolution that is sufficiently high to enable the identification of at least some synapses in the brain 706. Put another way, an image of the brain 706 may be referred to as having synaptic resolution if it depicts the brain 706 at a magnification level that is sufficiently high to enable the identification of at least some synapses in the brain 706. The image 710 can be a volumetric image, i.e., that characterizes a three-dimensional representation of the brain 706. The image 710 can be represented in any appropriate format, e.g., as a three-dimensional array of numerical values.

The imaging system 708 can be any appropriate system capable of generating synaptic resolution images, e.g., an electron microscopy system. The imaging system 708 can process “thin sections” from the brain 706 (i.e., thin slices of the brain attached to slides) to generate output images that each have a field of view corresponding to a proper subset of a thin section. The imaging system 708 can generate a complete image of each thin section by stitching together the images corresponding to different fields of view of the thin section using any appropriate image stitching technique. The imaging system 708 can generate the volumetric image 710 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

A graphing system 712 is configured to process the synaptic resolution image 710 to generate the synaptic connectivity graph 702. The synaptic connectivity graph 702 specifies a set of nodes and a set of edges, such that each edge connects two nodes. To generate the graph 702, the graphing system 712 identifies each neuronal element (e.g., each neuron, portion of a neuron, or group of neurons) in the image 710 as a respective node in the graph, and identifies each biological connection between a pair of neuronal elements in the image 710 as an edge between the corresponding pair of nodes in the graph.

The graphing system 712 can identify the neuronal elements and the biological connections depicted in the image 710 using any of a variety of techniques. For example, the graphing system 712 can process the image 710 to identify the positions of the neuronal elements depicted in the image 710, and determine whether a biological connection connects two neuronal elements based on the proximity of the neuronal elements (as will be described in more detail below). In this example, the graphing system 712 can process an input including: (i) the image, (ii) features derived from the image, or (iii) both, using a machine learning model that is trained using supervised learning techniques to identify neuronal elements in images. The machine learning model can be, e.g., a convolutional neural network model or a random forest model. The output of the machine learning model can include a neuronal element probability map that specifies a respective probability that each voxel in the image is included in a neuronal element. The graphing system 712 can identify contiguous clusters of voxels in the neuronal element probability map as being neuronal elements.

Optionally, prior to identifying the neuronal elements from the neuronal element probability map, the graphing system 712 can apply one or more filtering operations to the neuronal element probability map, e.g., with a Gaussian filtering kernel. Filtering the neuronal element probability map can reduce the amount of “noise” in the neuronal element probability map, e.g., where only a single voxel in a region is associated with a high likelihood of being a neuronal element.

The machine learning model used by the graphing system 712 to generate the neuronal element probability map can be trained using supervised learning training techniques on a set of training data. The training data can include a set of training examples, where each training example specifies: (i) a training input that can be processed by the machine learning model, and (ii) a target output that should be generated by the machine learning model by processing the training input. For example, the training input can be a synaptic resolution image of a brain, and the target output can be a “label map” that specifies a label for each voxel of the image indicating whether the voxel is included in a neuronal element. The target outputs of the training examples can be generated by manual annotation, e.g., where a person manually specifies which voxels of a training input are included in neuronal elements.

Example techniques for identifying the positions of neuronal elements depicted in the image 710 using neural networks (in particular, flood-filling neural networks) are described with reference to: P. H. Li et al.: “Automated Reconstruction of a Serial-Section EM Drosophila Brain with Flood-Filling Networks and Local Realignment,” bioRxiv doi:10.1101/605634 (2019).

The graphing system 712 can identify the biological connections connecting the neuronal elements in the image 710 (e.g., the synapses connecting the neurons in the image 710) based on the proximity of the neuronal elements. For example, the graphing system 712 can determine that a first neuronal element is connected by a biological connection to a second neuronal element based on the area of overlap between: (i) a tolerance region in the image around the first neuronal element, and (ii) a tolerance region in the image around the second neuronal element. That is, the graphing system 712 can determine whether the first neuronal element and the second neuronal element are connected based on the number of spatial locations (e.g., voxels) that are included in both: (i) the tolerance region around the first neuronal element, and (ii) the tolerance region around the second neuronal element. For example, the graphing system 712 can determine that two neuronal elements are connected if the overlap between the tolerance regions around the respective neuronal elements includes at least a predefined number of spatial locations (e.g., one spatial location). A “tolerance region” around a neuronal element refers to a contiguous region of the image that includes the neuronal element. For example, the tolerance region around a neuronal element can be specified as the set of spatial locations in the image that are either: (i) in the interior of the neuronal element, or (ii) within a predefined distance of the interior of the neuronal element.

The graphing system 712 can further identify a weight value associated with each edge in the graph 702. For example, the graphing system 712 can identify a weight for an edge connecting two nodes in the graph 702 based on the area of overlap between the tolerance regions around the respective neuronal elements corresponding to the nodes in the image 710. The area of overlap can be measured, e.g., as the number of voxels in the image 710 that are contained in the overlap of the respective tolerance regions around the neuronal elements. The weight for an edge connecting two nodes in the graph 702 may be understood as characterizing the (approximate) strength of the connection between the corresponding neuronal elements in the brain (e.g., the amount of information flow through the synapse connecting the two neurons).

In addition to identifying biological connections in the image 710, the graphing system 712 can further determine the direction of each biological connection using any appropriate technique. The “direction” of a biological connection between two neuronal elements refers to the direction of information flow between the two neuronal elements, e.g., if a first neuronal element uses a biological connection to transmit signals to a second neuronal element, then the direction of the biological connection would point from the first neuronal element to the second neuronal element. Example techniques for determining the directions of biological connections connecting pairs of neuronal elements are described with reference to: C. Seguin, A. Razi, and A. Zalesky: “Inferring neural signalling directionality from undirected structure connectomes,” Nature Communications 10, 4289 (2019), doi:10.1038/s41467-019-12201-w.

In implementations where the graphing system 712 determines the directions of the biological connections in the image 710, the graphing system 712 can associate each edge in the graph 702 with the direction of the corresponding biological connection. That is, the graph 702 can be a directed graph. In some other implementations, the graph 702 can be an undirected graph, i.e., where the edges in the graph are not associated with a direction.

The graph 702 can be represented in any of a variety of ways. For example, the graph 702 can be represented as a two-dimensional array of numerical values with a number of rows and columns equal to the number of nodes in the graph. The component of the array at position (i,j) can have value 1 if the graph includes an edge pointing from node i to node j, and value 0 otherwise. In implementations where the graphing system 712 determines a weight value for each edge in the graph 702, the weight values can be similarly represented as a two-dimensional array of numerical values. More specifically, if the graph includes an edge connecting node i to node j, the component of the array at position (i,j) can have a value given by the corresponding edge weight, and otherwise the component of the array at position (i,j) can have value 0.

An architecture mapping system 720 can process the synaptic connectivity graph 702 to determine the architecture of the brain emulation neural network 704 (or a brain emulation subnetwork of a neural network). For example, the architecture mapping system 720 can map each node in the graph 702 to: (i) an artificial neuron, (ii) a neural network layer, or (iii) a group of neural network layers, in the architecture of the brain emulation neural network 704. The architecture mapping system 720 can further map each edge of the graph 702 to a connection in the brain emulation neural network 704, e.g., such that a first artificial neuron that is connected to a second artificial neuron is configured to provide its output to the second artificial neuron. In some implementations, the architecture mapping system 720 can apply one or more transformation operations to the graph 702 before mapping the nodes and edges of the graph 702 to corresponding components in the architecture of the brain emulation neural network 704, as will be described in more detail below. An example architecture mapping system is described in more detail below with reference to FIG. 8.

The brain emulation neural network 704 can be configured to process manufacturing image data captured by one or more cameras that represents a manufactured article, and to generate a network output that represents a prediction about the presence of defects in the manufactured article.

The brain emulation neural network 704 can be provided to a training system 714 that trains the brain emulation neural network using machine learning techniques, i.e., generates an update to the respective values of one or more parameters of the brain emulation neural network.

In some implementations, the training system 714 is a supervised training system that is configured to train the brain emulation neural network 704 using a set of training data. The training data can include multiple training examples, where each training example specifies: (i) a training input that includes or is determined from a set of manufacturing image data characterizing a respective manufactured article, and (ii) a corresponding target output that should be generated by the brain emulation neural network 704 by processing the training input, i.e., that represents whether the manufactured article has a defect. In one example, the direct training system 714 can train the brain emulation neural network 704 over multiple training iterations using a gradient descent optimization technique, e.g., stochastic gradient descent. In this example, at each training iteration, the direct training system 714 can sample a “batch” (set) of one or more training examples from the training data, and process the training inputs specified by the training examples to generate corresponding network outputs. The direct training system 714 can evaluate an objective function that measures a similarity between: (i) the target outputs specified by the training examples, and (ii) the network outputs generated by the brain emulation neural network, e.g., a cross-entropy or squared-error objective function. The direct training system 714 can determine gradients of the objective function, e.g., using backpropagation techniques, and update the parameter values of the brain emulation neural network 704 using the gradients, e.g., using any appropriate gradient descent optimization algorithm, e.g., RMSprop or Adam.

In some other implementations, the training system 714 is a distillation training system that is configured to use the brain emulation neural network 704 to facilitate training of a “student” neural network having a less complex architecture than the brain emulation neural network 704. The complexity of a neural network architecture can be measured, e.g., by the number of parameters required to specify the operations performed by the neural network. The training system 714 can train the student neural network to match the outputs generated by the brain emulation neural network. After training, the student neural network can inherit the capacity of the brain emulation neural network 704 to effectively solve certain tasks, while consuming fewer computational resources (e.g., memory and computing power) than the brain emulation neural network 704. Typically, the training system 714 does not update the parameters of the brain emulation neural network 704 while training the student neural network. That is, in these implementations, the training system 714 is configured to train the student neural network instead of the brain emulation neural network 704.

As a particular example, the training system 714 can be a distillation training system that trains the student neural network in an adversarial manner. For example, the training system 714 can include a discriminator neural network that is configured to process network outputs that were generated either by the brain emulation neural network 704 or the student neural network, and to generate a prediction of whether the network outputs where generated by the brain emulation neural network 704 or the student neural network. The training system can then determine an update to the parameters of the student neural network in order to increase an error in the prediction of the discriminator neural network; that is, the goal of the student neural network is to generate network outputs that resemble network outputs generated by the brain emulation neural network 702 so that the discriminator neural network predicts that they were generated by the brain emulation neural network 704.

In some implementations, the brain emulation neural network 704 is a subnetwork of a neural network that includes one or more other neural network layers, e.g., one or more other subnetworks.

For example, the brain emulation neural network 704 can be a subnetwork of a “reservoir computing” neural network. The reservoir computing neural network can include i) the brain emulation neural network, which includes untrained parameters, and ii) one or more other subnetworks that include trained parameters. For example, the reservoir computing neural network can be configured to process a network input using the brain emulation neural network 704 to generate an alternative representation of the network input, and process the alternative representation of the network input using a “prediction” subnetwork to generate a network output.

During training of the reservoir computing neural network, the parameter values of the one or more other subnetworks (e.g., the prediction subnetwork) are trained, but the parameter values of the brain emulation neural network 704 are static, i.e., are not trained. Instead of being trained, the parameter values of the brain emulation neural network 704 can be determined from the weight values of the edges of the synaptic connectivity graph, as will be described in more detail below. The reservoir computing neural network facilitates application of the brain emulation neural network to machine learning tasks by obviating the need to train the parameter values of the brain emulation neural network 704.

After the training system 714 has completed training the brain emulation neural network 704 (or a neural network that includes the brain emulation neural network as a subnetwork, or a student neural network trained using the brain emulation neural network), the brain emulation neural network 704 can be deployed by a deployment system 722. That is, the operations of the brain emulation neural network 704 can be implemented on a device or a system of devices for performing inference, i.e., receiving network inputs and processing the network inputs to generate network outputs. In some implementations, the brain emulation neural network 704 can be deployed onto a cloud system, i.e., a distributed computing system having multiple computing nodes, e.g., hundreds or thousands of computing nodes, in one or more locations. In some other implementations, the brain emulation neural network 704 can be deployed onto a user device.

FIG. 8 shows an example architecture mapping system 800. The architecture mapping system 800 is an example of a system implemented as computer programs on one or more computers in one or more locations in which the systems, components, and techniques described below are implemented.

The architecture mapping system 800 is configured to process a synaptic connectivity graph 801 (e.g., the synaptic connectivity graph 702 depicted in FIG. 7) to determine a corresponding neural network architecture 802 of a brain emulation neural network 816 (e.g., the brain emulation neural network 704 depicted in FIG. 7). The brain emulation neural network 816 can be configured to process manufacturing image data representing a manufactured article, and to generate a prediction of whether the manufactured article is defective.

The architecture mapping system 800 can determine the architecture 802 using one or more of: a transformation engine 804, a feature generation engine 806, a node classification engine 808, and a nucleus classification engine 818, which will each be described in more detail next.

The transformation engine 804 can be configured to apply one or more transformation operations to the synaptic connectivity graph 801 that alter the connectivity of the graph 801, i.e., by adding or removing edges from the graph. A few examples of transformation operations follow.

In one example, to apply a transformation operation to the graph 801, the transformation engine 804 can randomly sample a set of node pairs from the graph (i.e., where each node pair specifies a first node and a second node). For example, the transformation engine can sample a predefined number of node pairs in accordance with a uniform probability distribution over the set of possible node pairs. For each sampled node pair, the transformation engine 804 can modify the connectivity between the two nodes in the node pair with a predefined probability (e.g., 0.1%). In one example, the transformation engine 804 can connect the nodes by an edge (i.e., if they are not already connected by an edge) with the predefined probability. In another example, the transformation engine 804 can reverse the direction of any edge connecting the two nodes with the predefined probability. In another example, the transformation engine 804 can invert the connectivity between the two nodes with the predefined probability, i.e., by adding an edge between the nodes if they are not already connected, and by removing the edge between the nodes if they are already connected.

In another example, the transformation engine 804 can apply a convolutional filter to a representation of the graph 801 as a two-dimensional array of numerical values. As described above, the graph 801 can be represented as a two-dimensional array of numerical values where the component of the array at position (i,j) can have value 1 if the graph includes an edge pointing from node i to node j, and value 0 otherwise. The convolutional filter can have any appropriate kernel, e.g., a spherical kernel or a Gaussian kernel. After applying the convolutional filter, the transformation engine 804 can quantize the values in the array representing the graph, e.g., by rounding each value in the array to 0 or 1, to cause the array to unambiguously specify the connectivity of the graph. Applying a convolutional filter to the representation of the graph 801 can have the effect of regularizing the graph, e.g., by smoothing the values in the array representing the graph to reduce the likelihood of a component in the array having a different value than many of its neighbors.

In some cases, the graph 801 can include some inaccuracies in representing the biological connectivity in the biological brain. For example, the graph can include nodes that are not connected by an edge despite the corresponding neurons in the brain being connected by a synapse, or “spurious” edges that connect nodes in the graph despite the corresponding neurons in the brain not being connected by a synapse. Inaccuracies in the graph can result, e.g., from imaging artifacts or ambiguities in the synaptic resolution image of the brain that is processed to generate the graph. Regularizing the graph, e.g., by applying a convolutional filter to the representation of the graph, can increase the accuracy with which the graph represents the biological connectivity in the brain, e.g., by removing spurious edges.

The architecture mapping system 800 can use the feature generation engine 806 and the node classification engine 808 to determine predicted “types” 810 of the neuronal elements corresponding to the nodes in the graph 801. The type of a neuronal element can characterize any appropriate aspect of the neuronal element. In one example, the type of a neuronal element can characterize the function performed by the neuronal element in the brain, e.g., a visual function by processing visual data, an olfactory function by processing odor data, or a memory function by retaining information. After identifying the types of the neuronal elements corresponding to the nodes in the graph 801, the architecture mapping system 800 can identify a sub-graph 812 of the overall graph 801 based on the neuronal element types, and determine the neural network architecture 802 based on the sub-graph 812. The feature generation engine 806 and the node classification engine 808 are described in more detail next.

The feature generation engine 806 can be configured to process the graph 801 (potentially after it has been modified by the transformation engine 804) to generate one or more respective node features 814 corresponding to each node of the graph 801. The node features corresponding to a node can characterize the topology (i.e., connectivity) of the graph relative to the node. In one example, the feature generation engine 806 can generate a node degree feature for each node in the graph 801, where the node degree feature for a given node specifies the number of other nodes that are connected to the given node by an edge. In another example, the feature generation engine 806 can generate a path length feature for each node in the graph 801, where the path length feature for a node specifies the length of the longest path in the graph starting from the node. A path in the graph may refer to a sequence of nodes in the graph, such that each node in the path is connected by an edge to the next node in the path. The length of a path in the graph may refer to the number of nodes in the path. In another example, the feature generation engine 806 can generate a neighborhood size feature for each node in the graph 801, where the neighborhood size feature for a given node specifies the number of other nodes that are connected to the node by a path of length at most N. In this example, N can be a positive integer value. In another example, the feature generation engine 806 can generate an information flow feature for each node in the graph 801. The information flow feature for a given node can specify the fraction of the edges connected to the given node that are outgoing edges, i.e., the fraction of edges connected to the given node that point from the given node to a different node.

In some implementations, the feature generation engine 806 can generate one or more node features that do not directly characterize the topology of the graph relative to the nodes. In one example, the feature generation engine 806 can generate a spatial position feature for each node in the graph 801, where the spatial position feature for a given node specifies the spatial position in the brain of the neuronal element corresponding to the node, e.g., in a Cartesian coordinate system of the synaptic resolution image of the brain. In another example, the feature generation engine 806 can generate a feature for each node in the graph 801 indicating whether the corresponding neuronal element is excitatory or inhibitory. In another example, the feature generation engine 806 can generate a feature for each node in the graph 801 that identifies the neuropil region associated with the neuronal element corresponding to the node.

In some cases, the feature generation engine 806 can use weights associated with the edges in the graph in determining the node features 814. As described above, a weight value for an edge connecting two nodes can be determined, e.g., based on the area of any overlap between tolerance regions around the neuronal elements corresponding to the nodes. In one example, the feature generation engine 806 can determine the node degree feature for a given node as a sum of the weights corresponding to the edges that connect the given node to other nodes in the graph. In another example, the feature generation engine 806 can determine the path length feature for a given node as a sum of the edge weights along the longest path in the graph starting from the node.

The node classification engine 808 can be configured to process the node features 814 to identify a predicted neuronal element type 810 corresponding to certain nodes of the graph 801. In one example, the node classification engine 808 can process the node features 814 to identify a proper subset of the nodes in the graph 801 with the highest values of the path length feature. For example, the node classification engine 808 can identify the nodes with a path length feature value greater than the 90th percentile (or any other appropriate percentile) of the path length feature values of all the nodes in the graph. The node classification engine 808 can then associate the identified nodes having the highest values of the path length feature with the predicted neuronal element type of “primary sensory neuronal element.” In another example, the node classification engine 808 can process the node features 814 to identify a proper subset of the nodes in the graph 801 with the highest values of the information flow feature, i.e., indicating that many of the edges connected to the node are outgoing edges. The node classification engine 808 can then associate the identified nodes having the highest values of the information flow feature with the predicted neuronal element type of “sensory neuronal element.” In another example, the node classification engine 808 can process the node features 814 to identify a proper subset of the nodes in the graph 801 with the lowest values of the information flow feature, i.e., indicating that many of the edges connected to the node are incoming edges (i.e., edges that point towards the node). The node classification engine 808 can then associate the identified nodes having the lowest values of the information flow feature with the predicted neuronal element type of “associative neuronal element.”

The architecture mapping system 800 can identify a sub-graph 812 of the overall graph 801 based on the predicted neuronal element types 810 corresponding to the nodes of the graph 801. A “sub-graph” may refer to a graph specified by: (i) a proper subset of the nodes of the graph 801, and (ii) a proper subset of the edges of the graph 801. FIG. 9 provides an illustration of an example sub-graph of an overall graph. In one example, the architecture mapping system 800 can select: (i) each node in the graph 801 corresponding to particular neuronal element type, and (ii) each edge in the graph 801 that connects nodes in the graph corresponding to the particular neuronal element type, for inclusion in the sub-graph 812. The neuronal element type selected for inclusion in the sub-graph can be, e.g., visual neuronal elements, olfactory neuronal elements, memory neuronal elements, or any other appropriate type of neuronal element. In some cases, the architecture mapping system 800 can select multiple neuronal element types for inclusion in the sub-graph 812, e.g., both visual neuronal elements and olfactory neuronal elements.

The type of neuronal element selected for inclusion in the sub-graph 812 can be determined based on the task which the brain emulation neural network 816 will be configured to perform, i.e., based on the fact that the brain emulation neural network 816 will be configured to perform defect detection. For example, because the brain emulation neural network 816 is to be configured to perform an image processing task (i.e., to process manufacturing image that includes one or more images of a manufactured article), a set of neuronal elements that are predicted to perform visual functions (i.e., by processing visual sensory data) can be selected for inclusion in the sub-graph 812.

If the edges of the graph 801 are associated with weight values (as described above), then each edge of the sub-graph 812 can be associated with the weight value of the corresponding edge in the graph 801. The sub-graph 812 can be represented, e.g., as a two-dimensional array of numerical values, as described with reference to the graph 801.

Determining the architecture 802 of the brain emulation neural network 816 based on the sub-graph 812 rather than the overall graph 801 can result in the architecture 802 having a reduced complexity, e.g., because the sub-graph 812 has fewer nodes, fewer edges, or both than the graph 801. Reducing the complexity of the architecture 802 can reduce consumption of computational resources (e.g., memory and computing power) by the brain emulation neural network 816, e.g., enabling the brain emulation neural network 816 to be deployed in resource-constrained environments, e.g., mobile devices. Reducing the complexity of the architecture 802 can also facilitate training of the brain emulation neural network 816, e.g., by reducing the amount of training data required to train the brain emulation neural network 816 to achieve an threshold level of performance (e.g., prediction accuracy).

In some cases, the architecture mapping system 800 can further reduce the complexity of the architecture 802 using a nucleus classification engine 818. In particular, the architecture mapping system 800 can process the sub-graph 812 using the nucleus classification engine 818 prior to determining the architecture 802. The nucleus classification engine 818 can be configured to process a representation of the sub-graph 812 as a two-dimensional array of numerical values (as described above) to identify one or more “clusters” in the array.

A cluster in the array representing the sub-graph 812 may refer to a contiguous region of the array such that at least a threshold fraction of the components in the region have a value indicating that an edge exists between the pair of nodes corresponding to the component. In one example, the component of the array in position (i,j) can have value 1 if an edge exists from node i to node j, and value 0 otherwise. In this example, the nucleus classification engine 818 can identify contiguous regions of the array such that at least a threshold fraction of the components in the region have the value 1. The nucleus classification engine 818 can identify clusters in the array representing the sub-graph 812 by processing the array using a blob detection algorithm, e.g., by convolving the array with a Gaussian kernel and then applying the Laplacian operator to the array. After applying the Laplacian operator, the nucleus classification engine 818 can identify each component of the array having a value that satisfies a predefined threshold as being included in a cluster.

Each of the clusters identified in the array representing the sub-graph 812 can correspond to edges connecting a “nucleus” (i.e., group) of related neuronal elements in brain, e.g., a thalamic nucleus, a vestibular nucleus, a dentate nucleus, or a fastigial nucleus. After the nucleus classification engine 818 identifies the clusters in the array representing the sub-graph 812, the architecture mapping system 800 can select one or more of the clusters for inclusion in the sub-graph 812. The architecture mapping system 800 can select the clusters for inclusion in the sub-graph 812 based on respective features associated with each of the clusters. The features associated with a cluster can include, e.g., the number of edges (i.e., components of the array) in the cluster, the average of the node features corresponding to each node that is connected by an edge in the cluster, or both. In one example, the architecture mapping system 800 can select a predefined number of largest clusters (i.e., that include the greatest number of edges) for inclusion in the sub-graph 812.

The architecture mapping system 800 can reduce the sub-graph 812 by removing any edge in the sub-graph 812 that is not included in one of the selected clusters, and then map the reduced sub-graph 812 to a corresponding neural network architecture, as will be described in more detail below. Reducing the sub-graph 812 by restricting it to include only edges that are included in selected clusters can further reduce the complexity of the architecture 802, thereby reducing computational resource consumption by the brain emulation neural network 816 and facilitating training of the brain emulation neural network 816.

The architecture mapping system 800 can determine the architecture 802 of the brain emulation neural network 816 from the sub-graph 812 in any of a variety of ways. For example, the architecture mapping system 800 can map each node in the sub-graph 812 to a corresponding: (i) artificial neuron, (ii) artificial neural network layer, or (iii) group of artificial neural network layers in the architecture 802, as will be described in more detail next.

In one example, the neural network architecture 802 can include: (i) a respective artificial neuron corresponding to each node in the sub-graph 812, and (ii) a respective connection corresponding to each edge in the sub-graph 812. In this example, the sub-graph 812 can be a directed graph, and an edge that points from a first node to a second node in the sub-graph 812 can specify a connection pointing from a corresponding first artificial neuron to a corresponding second artificial neuron in the architecture 802. The connection pointing from the first artificial neuron to the second artificial neuron can indicate that the output of the first artificial neuron should be provided as an input to the second artificial neuron. Each connection in the architecture can be associated with a weight value, e.g., that is specified by the weight value associated with the corresponding edge in the sub-graph. An artificial neuron may refer to a component of the architecture 802 that is configured to receive one or more inputs (e.g., from one or more other artificial neurons), and to process the inputs to generate an output. The inputs to an artificial neuron and the output generated by the artificial neuron can be represented as scalar numerical values. In one example, a given artificial neuron can generate an output b as:

$$b = σ ( {\sum }_{i = 1}^{n} {w}_{i} \cdot {a}_{i} ) \qquad ( 1 )$$

where σ(·) is a non-linear “activation” function (e.g., a sigmoid function or an arctangent function), {aᵢ}ᵢ₌₁ⁿ are the inputs provided to the given artificial neuron, and {wᵢ}ᵢ₌₁ⁿ are the weight values associated with the connections between the given artificial neuron and each of the other artificial neurons that provide an input to the given artificial neuron.

In another example, the sub-graph 812 can be an undirected graph, and the architecture mapping system 800 can map an edge that connects a first node to a second node in the sub-graph 812 to two connections between a corresponding first artificial neuron and a corresponding second artificial neuron in the architecture. In particular, the architecture mapping system 800 can map the edge to: (i) a first connection pointing from the first artificial neuron to the second artificial neuron, and (ii) a second connection pointing from the second artificial neuron to the first artificial neuron.

In another example, the sub-graph 812 can be an undirected graph, and the architecture mapping system can map an edge that connects a first node to a second node in the sub-graph 812 to one connection between a corresponding first artificial neuron and a corresponding second artificial neuron in the architecture. The architecture mapping system 800 can determine the direction of the connection between the first artificial neuron and the second artificial neuron, e.g., by randomly sampling the direction in accordance with a probability distribution over the set of two possible directions.

In some cases, the edges in the sub-graph 812 is not be associated with weight values, and the weight values corresponding to the connections in the architecture 802 can be determined randomly. For example, the weight value corresponding to each connection in the architecture 802 can be randomly sampled from a predetermined probability distribution, e.g., a standard Normal (N(0,1)) probability distribution.

In another example, the neural network architecture 802 can include: (i) a respective artificial neural network layer corresponding to each node in the sub-graph 812, and (ii) a respective connection corresponding to each edge in the sub-graph 812. In this example, a connection pointing from a first layer to a second layer can indicate that the output of the first layer should be provided as an input to the second layer. An artificial neural network layer may refer to a collection of artificial neurons, and the inputs to a layer and the output generated by the layer can be represented as ordered collections of numerical values (e.g., tensors of numerical values). In one example, the architecture 802 can include a respective convolutional neural network layer corresponding to each node in the sub-graph 812, and each given convolutional layer can generate an output d as:

$$d = σ ( {h}_{θ} ( {\sum }_{i = 1}^{n} {w}_{i} \cdot {c}_{i} ) ) \qquad ( 2 )$$

where each cᵢ (i=1, . . . n) is a tensor (e.g., a two- or three-dimensional array) of numerical values provided as an input to the layer, each wᵢ (i=1, . . . , n) is a weight value associated with the connection between the given layer and each of the other layers that provide an input to the given layer (where the weight value for each edge can be specified by the weight value associated with the corresponding edge in the sub-graph), h_{θ}(·) represents the operation of applying one or more convolutional kernels to an input to generate a corresponding output, and σ(·) is a non-linear activation function that is applied element-wise to each component of its input. In this example, each convolutional kernel can be represented as an array of numerical values, e.g., where each component of the array is randomly sampled from a predetermined probability distribution, e.g., a standard Normal probability distribution.

In another example, the architecture mapping system 800 can determine that the neural network architecture includes: (i) a respective group of artificial neural network layers corresponding to each node in the sub-graph 812, and (ii) a respective connection corresponding to each edge in the sub-graph 812. The layers in a group of artificial neural network layers corresponding to a node in the sub-graph 812 can be connected, e.g., as a linear sequence of layers, or in any other appropriate manner.

Various operations performed by the described architecture mapping system 800 are optional or can be implemented in a different order. For example, the architecture mapping system 800 can refrain from applying transformation operations to the graph 801 using the transformation engine 804, and refrain from extracting a sub-graph 812 from the graph 801 using the feature generation engine 806, the node classification engine 808, and the nucleus classification engine 818. In this example, the architecture mapping system 800 can directly map the graph 801 to the neural network architecture 802, e.g., by mapping each node in the graph to an artificial neuron and mapping each edge in the graph to a connection in the architecture, as described above.

FIG. 9 illustrates an example graph 900 and an example sub-graph 902. Each node in the graph 900 is represented by a circle (e.g., 904 and 906), and each edge in the graph 900 is represented by a line (e.g., 908 and 910). In this illustration, the graph 900 can be considered a simplified representation of a synaptic connectivity graph (an actual synaptic connectivity graph can have far more nodes and edges than are depicted in FIG. 9). A sub-graph 902 can be identified in the graph 900, where the sub-graph 902 includes a proper subset of the nodes and edges of the graph 900. In this example, the nodes included in the sub-graph 902 are hatched (e.g., 906) and the edges included in sub-graph 902 are dashed (e.g., 910). The nodes included in the sub-graph 902 can correspond to neuronal elements of a particular type, e.g., neuronal elements having a particular function, e.g., visual neuronal elements. The architecture of the brain emulation neural network can be specified by the structure of the entire graph 900, or by the structure of a sub-graph 902, as described above.

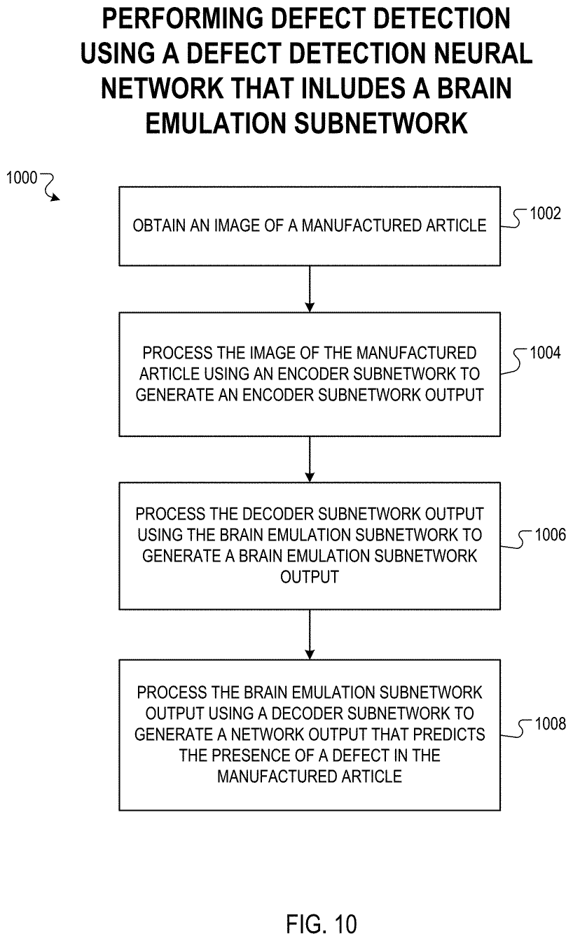

FIG. 10 is a flow diagram of an example process 1000 for performing defect detection using a defect detection neural network that includes a brain emulation subnetwork. For convenience, the process 1000 will be described as being performed by a system of one or more computers located in one or more locations. For example, a neural network computing system, e.g., the neural network computing system 100 depicted in FIG. 1B, appropriately programmed in accordance with this specification, can perform the process 1000.

The system obtains an image of a manufactured article (step 1002).

The system can then process the image of the manufactured article using the defect detection neural network to generate a network output that predicts the presence of a defect in the manufactured article. The operations of the defect detection neural network are described in more detail below with reference to steps 1004, 1006, and 1008.

The system processes the image of the manufactured article using an encoder subnetwork of the defect detection neural network to generate an encoder subnetwork output (step 1004). The encoder subnetwork can include one or more non-biological neural network layers.

The system processes the encoder subnetwork output using the brain emulation subnetwork of the defect detection neural network to generate a brain emulation subnetwork output (step 1006). The brain emulation subnetwork can have a brain emulation neural network architecture that includes multiple brain emulation parameters that, when initialized, represent biological connectivity between a set of biological neuronal elements in a brain of a biological organism.

The system processes the brain emulation subnetwork output using a decoder subnetwork of the defect detection neural network to generate the network output that predicts the presence of a defect in the manufactured article (step 1008). The decoder subnetwork can include one or more non-biological neural network layers.

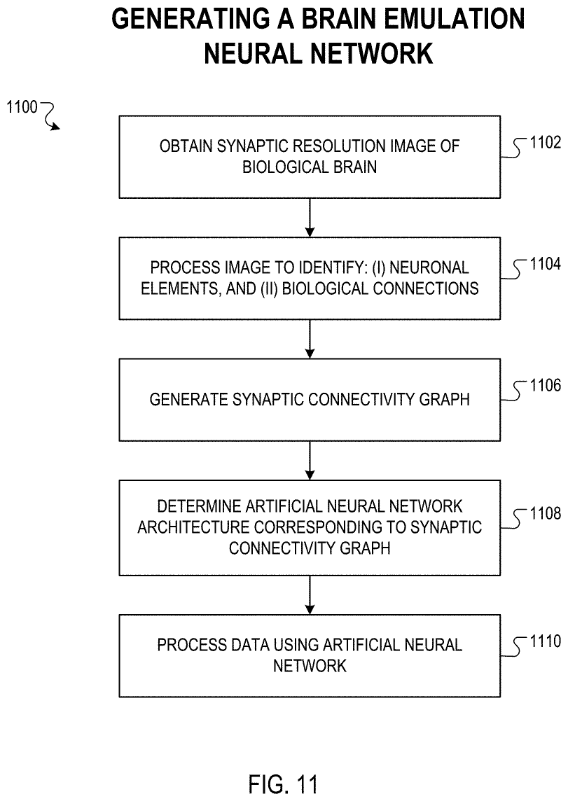

FIG. 11 is a flow diagram of an example process 1100 for generating a brain emulation neural network. For convenience, the process 1100 will be described as being performed by a system of one or more computers located in one or more locations.

The system obtains a synaptic resolution image of at least a portion of a brain of a biological organism (1102).

The system processes the image to identify: (i) neuronal elements in the brain, and (ii) biological connections between the neuronal elements in the brain (1104).

The system generates data defining a graph representing biological connectivity between the neuronal elements in the brain (1106). The graph includes a set of nodes and a set of edges, where each edge connects a pair of nodes. The system identifies each neuronal element in the brain as a respective node in the graph, and each biological connection between a pair of neuronal elements in the brain as an edge between a corresponding pair of nodes in the graph.

The system determines an artificial neural network architecture corresponding to the graph representing the biological connectivity between the neuronal elements in the brain (1108).

The system processes a network input using an artificial neural network having the artificial neural network architecture to generate a network output (1110).

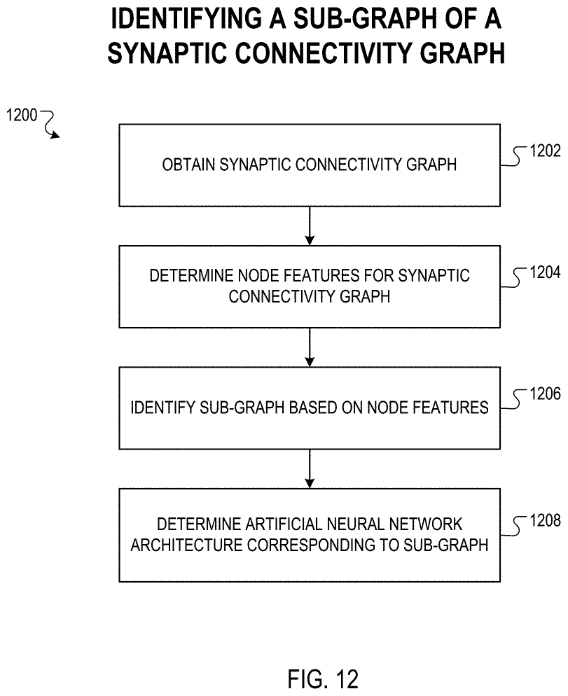

FIG. 12 is a flow diagram of an example process 1200 for determining an artificial neural network architecture corresponding to a sub-graph of a synaptic connectivity graph. For convenience, the process 1200 will be described as being performed by a system of one or more computers located in one or more locations. For example, an architecture mapping system, e.g., the architecture mapping system 800 of FIG. 8, appropriately programmed in accordance with this specification, can perform the process 1200.

The system obtains data defining a graph representing biological connectivity between neuronal elements in a brain of a biological organism (1202). The graph includes a set of nodes and edges, where each edge connects a pair of nodes. Each node corresponds to a respective neuronal element in the brain of the biological organism, and each edge connecting a pair of nodes in the graph corresponds to a biological connection between a pair of neuronal elements in the brain of the biological organism.

The system determines, for each node in the graph, a respective set of one or more node features characterizing a structure of the graph relative to the node (1204).

The system identifies a sub-graph of the graph (1206). In particular, the system selects a proper subset of the nodes in the graph for inclusion in the sub-graph based on the node features of the nodes in the graph.

The system determines an artificial neural network architecture corresponding to the sub-graph of the graph (1208).

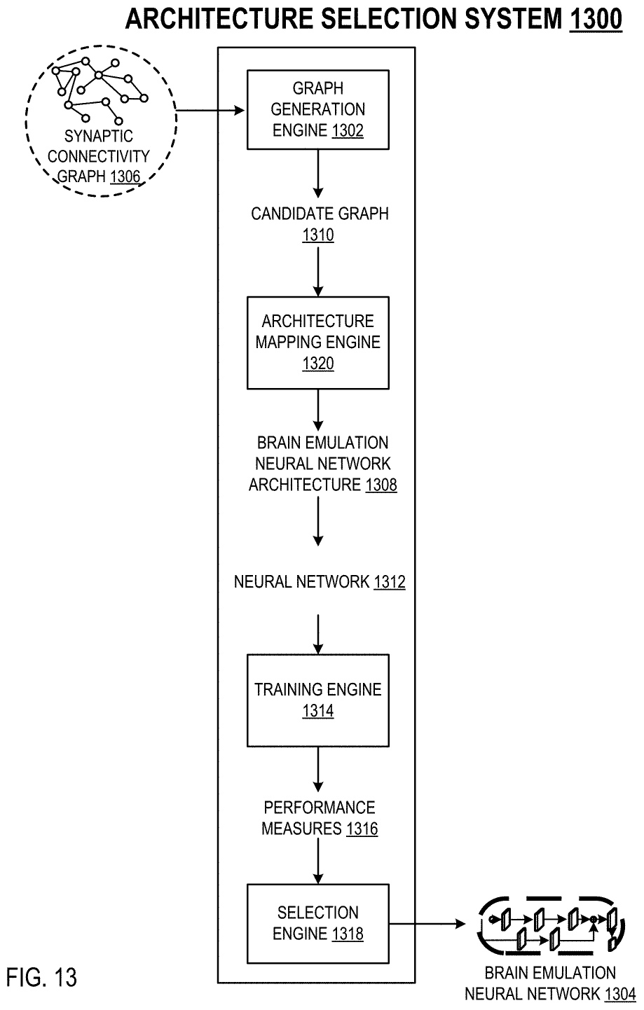

FIG. 13 is an example architecture selection system 1300. The architecture selection system 1300 is an example of a system implemented as computer programs on one or more computers in one or more locations in which the systems, components, and techniques described below are implemented.

The system 1300 is configured to search a space of possible neural network architectures to identify the neural network architecture of a brain emulation neural network 1304 to be included in a neural network (e.g., the network 102 in FIG. 1B or the network 502 in FIG. 5). The neural network can be configured to process manufacturing image data representing a manufactured article, and generate a prediction of whether the manufactured article has a defect. In some implementations, the system 1300 can identify multiple brain emulation neural networks 1304 to be included in the neural network.

The system 1300 can seed the search through the space of possible neural network architectures using a synaptic connectivity graph 1306 representing biological connectivity in the brain of a biological organism. The synaptic connectivity graph 1306 may be derived directly from a synaptic resolution image of the brain of a biological organism, e.g., as described with reference to FIG. 6. In some cases, the synaptic connectivity graph 1306 may be a sub-graph of a larger graph derived from a synaptic resolution image of a brain, e.g., a sub-graph that includes neuronal elements of a particular type, e.g., neuronal elements that process sensory inputs that are of the same type as (or that are otherwise similar to) the manufacturing image data that the neural network is configured to process, e.g., visual neuronal elements.

The system 1300 includes a graph generation engine 1302, an architecture mapping engine 1320, a training engine 1314, and a selection engine 1318, each of which will be described in more detail next.

The graph generation engine 1302 is configured to process the synaptic connectivity graph 1306 to generate multiple “candidate” graphs 1310, where each candidate graph is defined by a set of nodes and a set of edges, such that each edge connects a pair of nodes.

The graph generation engine 1302 may generate the candidate graphs 1310 from the synaptic connectivity graph 1306 using any of a variety of techniques. A few examples follow.

In one example, the graph generation engine 1302 may generate a candidate graph 1310 at each of multiple iterations by processing the synaptic connectivity graph 1306 in accordance with current values of a set of graph generation parameters. The current values of the graph generation parameters may specify (transformation) operations to be applied to an adjacency matrix representing the synaptic connectivity graph 1306 to generate an adjacency matrix representing a candidate graph 1310. The operations to be applied to the adjacency matrix representing the synaptic connectivity graph may include, e.g., filtering operations, cropping operations, or both. The candidate graph 1310 may be defined by the result of applying the operations specified by the current values of the graph generation parameters to the adjacency matrix representing the synaptic connectivity graph 1306.

The graph generation engine 1302 may apply a filtering operation to the adjacency matrix representing the synaptic connectivity graph 1306, e.g., by convolving a filtering kernel with the adjacency matrix representing the synaptic connectivity graph. The filtering kernel may be defined by a two-dimensional matrix, where the components of the matrix are specified by the graph generation parameters. Applying a filtering operation to the adjacency matrix representing the synaptic connectivity graph 1306 may have the effect of adding edges to the synaptic connectivity graph 1306, removing edges from the synaptic connectivity graph 1306, or both.

The graph generation engine 1302 may apply a cropping operation to the adjacency matrix representing the synaptic connectivity graph 1306, where the cropping operation replaces the adjacency matrix representing the synaptic connectivity graph 1306 with an adjacency matrix representing a sub-graph of the synaptic connectivity graph 1306. Generally, a “sub-graph” may refer to a graph specified by: (i) a proper subset of the nodes of the graph 1306, and (ii) a proper subset of the edges of the graph 1306. The cropping operation may specify a sub-graph of synaptic connectivity graph 1306, e.g., by specifying a proper subset of the rows and a proper subset of the columns of the adjacency matrix representing the synaptic connectivity graph 1306 that define a sub-matrix of the adjacency matrix. The sub-graph may include: (i) each edge specified by the sub-matrix, and (ii) each node that is connected by an edge specified by the sub-matrix.

At each iteration, the system 1300 determines a performance measure 1316 corresponding to the candidate graph 1310 generated at the iteration, and the system 1300 updates the current values of the graph generation parameters to encourage the generation of candidate graphs 1310 with higher performance measures 1316. The performance measure 1316 for a candidate graph 1310 characterizes the performance of a neural network that includes a brain emulation neural network having an architecture specified by the candidate graph 1310 at performing a machine learning task. Determining performance measures 1316 for candidate graphs 1310 will be described in more detail below. The system 1300 may use any appropriate optimization technique to update the current values of the graph generation parameters, e.g., a “black-box” optimization technique that does not rely on computing gradients of the operations performed by the graph generation engine 1302. Examples of black-box optimization techniques which may be implemented by the optimization engine are described with reference to: Golovin, D., Solnik, B., Moitra, S., Kochanski, G., Karro, J., & Sculley, D.: “Google vizier: A service for black-box optimization,” In Proceedings of the 23rd ACM SIGKDD International Conference on Knowledge Discovery and Data Mining, pp. 1487-1495 (2017). Prior to the first iteration, the values of the graph generation parameters may be set to default values or randomly initialized.

In another example, the graph generation engine 1302 may generate the candidate graphs 1310 by “evolving” a population (i.e., a set) of graphs derived from the synaptic connectivity graph 1306 over multiple iterations. The graph generation engine 1302 may initialize the population of graphs, e.g., by “mutating” multiple copies of the synaptic connectivity graph 1306. Mutating a graph refers to making a random change to the graph, e.g., by randomly adding or removing edges or nodes from the graph. After initializing the population of graphs, the graph generation engine 1302 may generate a candidate graph at each of multiple iterations by, at each iteration, selecting a graph from the population of graphs derived from the synaptic connectivity graph and mutating the selected graph to generate a candidate graph 1310. The graph generation engine 1302 may determine a performance measure 1316 for the candidate graph 1310, and use the performance measure to determine whether the candidate graph 1310 is added to the current population of graphs.

In some implementations, each edge of the synaptic connectivity graph may be associated with a weight value that is determined from the synaptic resolution image of the brain, as described above. Each candidate graph may inherit the weight values associated with the edges of the synaptic connectivity graph. For example, each edge in the candidate graph that corresponds to an edge in the synaptic connectivity graph may be associated with the same weight value as the corresponding edge in the synaptic connectivity graph. Edges in the candidate graph that do not correspond to edges in the synaptic connectivity graph may be associated with default or randomly initialized weight values.

In another example, the graph generation engine 1302 can generate each candidate graph 1310 as a sub-graph of the synaptic connectivity graph 1306. For example, the graph generation engine 1302 can randomly select sub-graphs, e.g., by randomly selecting a proper subset of the rows and a proper subset of the columns of the adjacency matrix representing the synaptic connectivity graph 1306 that define a sub-matrix of the adjacency matrix. The sub-graph may include: (i) each edge specified by the sub-matrix, and (ii) each node that is connected by an edge specified by the sub-matrix.

The architecture mapping engine 1320 processes each candidate graph 1310 to generate a corresponding brain emulation neural network architecture 1308. The architecture mapping engine 1320 may use the candidate graph 1310 derived from the synaptic connectivity graph 1306 to specify the brain emulation neural network architecture 1308 in any of a variety of ways. For example, the architecture mapping engine 1320 may map each node in the candidate graph 1310 to a corresponding: (i) artificial neuron, (ii) artificial neural network layer, or (iii) group of artificial neural network layers in the brain emulation neural network architecture 1308, as will be described in more detail next.

In one example, the brain emulation neural network architecture 1308 can include: (i) a respective artificial neuron corresponding to each node in the candidate graph 1310, and (ii) a respective connection corresponding to each edge in the candidate graph 1310. In this example, the graph can be a directed graph, and an edge that points from a first node to a second node in the graph can specify a connection pointing from a corresponding first artificial neuron to a corresponding second artificial neuron in the architecture. The connection pointing from the first artificial neuron to the second artificial neuron can indicate that the output of the first artificial neuron should be provided as an input to the second artificial neuron. Each connection in the architecture can be associated with a weight value, e.g., that is specified by the weight value associated with the corresponding edge in the graph.

An artificial neuron can refer to a component of the architecture that is configured to receive one or more inputs (e.g., from one or more other artificial neurons), and to process the inputs to generate an output. The inputs to an artificial neuron and the output generated by the artificial neuron can be represented as scalar numerical values. In one example, a given artificial neuron can generate an output b by executing equation (1) above.

In another example, the candidate graph 1310 can be an undirected graph, and the architecture mapping engine 1320 can map an edge that connects a first node to a second node in the graph to two connections between a corresponding first artificial neuron and a corresponding second artificial neuron in the architecture. In particular, the architecture mapping engine 1320 can map the edge to: (i) a first connection pointing from the first artificial neuron to the second artificial neuron, and (ii) a second connection pointing from the second artificial neuron to the first artificial neuron.

In another example, the candidate graph 1310 can be an undirected graph, and the architecture mapping engine 1320 can map an edge that connects a first node to a second node in the graph to one connection between a corresponding first artificial neuron and a corresponding second artificial neuron in the architecture. The architecture mapping engine 1320 can determine the direction of the connection between the first artificial neuron and the second artificial neuron, e.g., by randomly sampling the direction in accordance with a probability distribution over the set of two possible directions.

In some cases, the edges in the candidate graph are not associated with weight values, and the weight values corresponding to the connections in the architecture can be determined randomly. For example, the weight value corresponding to each connection in the architecture can be randomly sampled from a predetermined probability distribution, e.g., a standard Normal (N(0,1)) probability distribution.

In another example, the brain emulation neural network architecture 1308 can include: (i) a respective artificial neural network layer corresponding to each node in the candidate graph, and (ii) a respective connection corresponding to each edge in the candidate graph. In this example, a connection pointing from a first layer to a second layer can indicate that the output of the first layer should be provided as an input to the second layer. An artificial neural network layer can refer to a collection of artificial neurons, and the inputs to a layer and the output generated by the layer can be represented as ordered collections of numerical values (e.g., tensors of numerical values). In one example, the architecture can include a respective convolutional neural network layer corresponding to each node in the graph, and each given convolutional layer can generate an output d by executing equation (2) above. In this example, each convolutional kernel can be represented as an array of numerical values, e.g., where each component of the array is randomly sampled from a predetermined probability distribution, e.g., a standard Normal probability distribution.

In another example, the architecture mapping engine 1320 can determine that the brain emulation neural network architecture includes: (i) a respective group of artificial neural network layers corresponding to each node in the graph, and (ii) a respective connection corresponding to each edge in the graph. The layers in a group of artificial neural network layers corresponding to a node in the graph can be connected, e.g., as a linear sequence of layers, or in any other appropriate manner.

The architecture of a brain emulation sub-network can directly represent biological connectivity in a region of the brain of the biological organism. More specifically, the system can map the nodes of the candidate graph (which each represent, e.g., a biological neuronal element in the brain) onto corresponding artificial neurons in the brain emulation sub-network. The system can also map the edges of the candidate graph (which each represent, e.g., a biological connection between a pair of neuronal elements in the brain) onto connections between corresponding pairs of artificial neurons in the brain emulation sub-network. The system can map the respective weight associated with each edge in the candidate graph to a corresponding weight (i.e., parameter value) of a corresponding connection in the brain emulation sub-network. The weight corresponding to an edge (representing, e.g., a biological connection in the brain) between a pair of nodes in the candidate graph (representing a pair of biological neuronal elements in the brain) can represent a proximity of the pair of biological neuronal elements in the brain, as described above.

For each brain emulation neural network architecture 1308, the training engine 1314 instantiates a neural network 1312, e.g., the neural network 102 described with reference to FIG. 1B, or the neural network 502 described with reference to FIG. 5. The neural network 1312 can include a brain emulation sub-network that has the brain emulation neural network architecture 1308 and acts as the reservoir. In particular, a neural network can include multiple brain emulation sub-networks. Accordingly, the training engine 1314 can instantiate multiple neural networks 1312 having any appropriate configuration of multiple brain emulation sub-networks. In one example, the training engine 1314 can instantiate a neural network having multiple copies of the same brain emulation sub-network. In another example, the training engine 1314 can instantiate a neural network having multiple different brain emulation sub-networks, e.g., multiple sub-networks that are each specified by a different candidate graph 1310. The training engine 1314 can instantiate any appropriate number and configuration of the neural networks, including any appropriate number and configuration of brain emulation sub-networks, and evaluate each neural network at the same machine learning task, as will be described in more detail next.

Each neural network 1312 is configured to perform the defect detection task. The training engine 1314 is configured to train each neural network 1312 over multiple training iterations.

The training engine 1314 determines a respective performance measure 1316 of each neural network 1312 on the defect detection task. For example, the training engine 1314 can train the neural network 1312 on a set of training data over a sequence of training iterations, e.g., using the training engine 516 described with reference to FIG. 5. The training engine 1314 can then evaluate the performance of the neural network 1312 on a set of validation data, e.g., that includes a set of training examples that are part of the training data used to train the neural network 1312. The training engine 1314 can evaluate the performance of the neural network 1312 on the set of validation data, e.g., by computing an average error (e.g., cross-entropy error or squared-error) in network outputs generated by the neural network for the validation data.

The selection engine 1318 uses the performance measures 1316 to generate the output brain emulation neural network 1304. In one example, the selection engine 1318 may generate a brain emulation neural network 1304 having the brain emulation neural network architecture 1308 associated with the best (e.g., highest) performance measure 1316. The output brain emulation neural network 1304 can then be included in, e.g., the neural network 102 described with reference to FIG. 1B.

As described above, the brain emulation neural network architecture can be specified by a synaptic connectivity graph that represents the structure of biological connections in the brain of the biological organism. The synaptic connectivity graph can be obtained from a synaptic resolution image of the brain of the biological organism, as is described in more detail above.

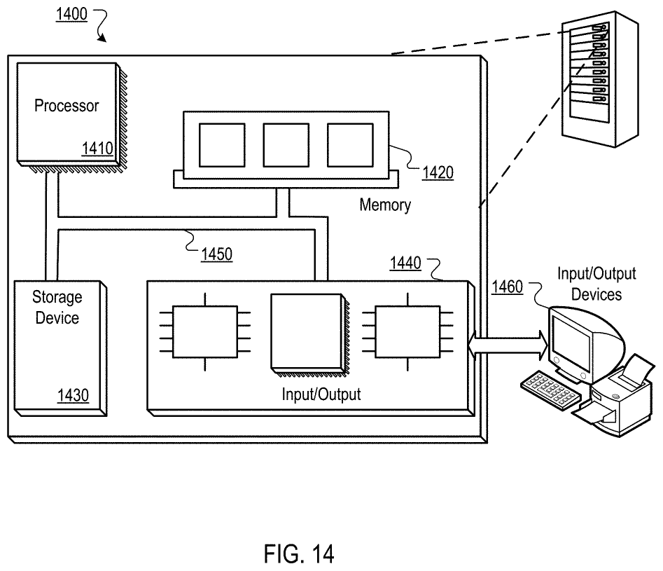

FIG. 14 is a block diagram of an example computer system 1400 that can be used to perform operations described previously. The system 1400 includes a processor 1410, a memory 1420, a storage device 1430, and an input/output device 1440. Each of the components 1410, 1420, 1430, and 1440 can be interconnected, for example, using a system bus 1450. The processor 1410 is capable of processing instructions for execution within the system 1400. In one implementation, the processor 1410 is a single-threaded processor. In another implementation, the processor 1410 is a multi-threaded processor. The processor 1410 is capable of processing instructions stored in the memory 1420 or on the storage device 1430.

The memory 1420 stores information within the system 1400. In one implementation, the memory 1420 is a computer-readable medium. In one implementation, the memory 1420 is a volatile memory unit. In another implementation, the memory 1420 is a non-volatile memory unit.

The storage device 1430 is capable of providing mass storage for the system 1400. In one implementation, the storage device 1430 is a computer-readable medium. In various different implementations, the storage device 1430 can include, for example, a hard disk device, an optical disk device, a storage device that is shared over a network by multiple computing devices (for example, a cloud storage device), or some other large capacity storage device.

The input/output device 1440 provides input/output operations for the system 1400. In one implementation, the input/output device 1440 can include one or more network interface devices, for example, an Ethernet card, a serial communication device, for example, and RS-232 port, and/or a wireless interface device, for example, and 802.11 card. In another implementation, the input/output device 1440 can include driver devices configured to receive input data and send output data to other input/output devices, for example, keyboard, printer and display devices 1460. Other implementations, however, can also be used, such as mobile computing devices, mobile communication devices, and set-top box television client devices.

Although an example processing system has been described in FIG. 14, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network.

The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:

obtaining an image of a manufactured article;

processing the image of the manufactured article using a defect detection neural network to generate a network output that predicts whether the manufactured article includes a defect, comprising:
processing the image of the manufactured article using an encoder subnetwork of the defect detection neural network to generate an encoder subnetwork output;
processing the encoder subnetwork output using a brain emulation subnetwork of the defect detection neural network to generate a brain emulation subnetwork output, wherein the brain emulation subnetwork has a brain emulation neural network architecture that comprises a plurality of brain emulation parameters that, when initialized, represent biological connectivity between a plurality of biological neuronal elements in a brain of a biological organism; and
processing the brain emulation subnetwork output using a decoder subnetwork of the defect detection neural network to generate the network output that predicts whether the manufactured article includes the defect; and

taking an action based on the network output that predicts whether the manufactured article includes the defect.

Embodiment 2 is the method of embodiment 1, further comprising:

determining, from the network output, that the manufactured article includes the defect.

Embodiment 3 is the method of embodiment 2, further comprising one or more of:

determining, from the network output, a type of defect that is included in the manufactured article; or

determining, from the network output, a portion of the manufactured article that includes the defect.

Embodiment 4 is the method of any one of embodiments 2 or 3, wherein taking the action based on the network output comprises:

in response to determining that the manufactured article includes the defect, providing one or more of (i) the manufactured article or (ii) the image of the manufactured article, for human inspection.

Embodiment 5 is the method of any one of embodiments 1-4, wherein the image of the manufactured article was captured by a camera directed at an assembly line carrying a plurality of manufactured articles.

Embodiment 6 is the method of any one of embodiments 1-5, wherein the network output comprises one or more of:

a classification of the manufactured article as either defective or not defective, or

a segmentation of the image of the manufactured article into a plurality of categories including at least one defect category.

Embodiment 7 is the method of embodiment 6, wherein:

the network output comprises both the classification of the manufactured article and the segmentation of the image of the manufactured article, and

the method further comprises determining, from the network output, that the manufactured article includes the defect only if the classification of the manufactured article and the segmentation of the image of the manufactured article both indicate that the manufactured article includes the defect.

Embodiment 8 is the method of any one of embodiments 6 or 7, wherein the plurality of categories of the segmentation comprises a plurality of categories corresponding to respective possible types of defects.

Embodiment 9 is the method of any one of embodiments 1-8, wherein the defect detection neural network has been trained using a loss function that penalizes false-negative predictions more than false-positive predictions.

Embodiment 10 is the method of any one of embodiments 1-9, wherein the defect detection neural network is configured to process one or more different modalities of images of manufactured articles, the one or more modalities comprising one or more of: visible-light images, infrared images, x-ray images, ultraviolet images, multispectral images, hyperspectral images, or LIDAR images.

Embodiment 11 is the method of any one of embodiments 1-10, wherein the defect detection neural network has been trained using one or more auxiliary machine learning tasks that are different from predicting the presence of a defect in the manufactured article, the training comprising:

for each of the one or more auxiliary machine learning tasks:
processing a training image using the defect detection neural network to generate an auxiliary output for the auxiliary machine learning task, and
updating a set of network parameters of the defect detection neural network according to an error in the auxiliary output.

Embodiment 12 is the method of embodiment 11, wherein the one or more auxiliary machine learning tasks comprise one or more of:

predicting a region of interest on the manufactured article,

predicting an orientation of the manufactured article,

predicting a color of the manufactured article, or

predicting a type of material included in the manufactured article.

Embodiment 13 is the method of any one of embodiments 1-12, wherein the plurality of brain emulation parameters represent biological connectivity between a strict subset of the plurality of biological neuronal elements in the brain of the biological organism, wherein each biological neuronal element in the strict subset processes visual sensory inputs in the brain of the biological organism.

Embodiment 14 is the method of any one of embodiments 1-13, wherein the plurality of brain emulation parameters representing synaptic connectivity between the plurality of biological neurons in the brain of the biological organism are arranged in a two-dimensional weight matrix having a plurality of rows and a plurality of columns,

wherein each row and each column of the weight matrix corresponds to a respective biological neuron from the plurality of biological neurons, and

wherein each brain emulation parameter in the weight matrix corresponds to a respective pair of biological neurons in the brain of the biological organism, the pair comprising: (i) the biological neuron corresponding to a row of the brain emulation parameter in the weight matrix, and (ii) the biological neuron corresponding to a column of the brain emulation parameter in the weight matrix.

Embodiment 15 is the method of embodiment 14, wherein each brain emulation parameter of the weight matrix has a respective value that characterizes synaptic connectivity in the brain of the biological organism between the respective pair of biological neurons corresponding to the brain emulation parameter.

Embodiment 16 is the method of embodiment 15, wherein each brain emulation parameter of the weight matrix that corresponds to a respective pair of biological neurons that are not connected by a synaptic connection in the brain of the biological organism has value zero.

Embodiment 17 is the method of any one of embodiments 15 or 16, wherein each brain emulation parameter of the weight matrix that corresponds to a respective pair of biological neurons that are connected by a synaptic connection in the brain of the biological organism has a respective non-zero value characterizing an estimated strength of the synaptic connection.

Embodiment 18 is the method of any one of embodiments 1-17, wherein the brain emulation neural network architecture is determined from a synaptic connectivity graph that represents the synaptic connectivity between the biological neurons in the brain of the biological organism,

wherein the synaptic connectivity graph comprises a plurality of nodes and edges, each edge connects a pair of nodes, each node corresponds to a respective neuron in the brain of the biological organism, and each edge connecting a pair of nodes in the synaptic connectivity graph corresponds to a synaptic connection between a pair of biological neurons in the brain of the biological organism.

Embodiment 19 is the method of any one of embodiments 1-18, wherein:

the encoder subnetwork comprises a sequence of multiple encoder blocks, wherein:
each encoder block is configured to process a respective encoder block input to generate a respective encoder block output, wherein a spatial resolution of the encoder block output is lower than a spatial resolution of the encoder block input, and
for each encoder block that is after an initial encoder block in the sequence of encoder blocks, the encoder block input comprises a previous encoder block output of a previous encoder block in the sequence of encoder blocks; and

the decoder subnetwork comprises a sequence of multiple decoder blocks, wherein:
each decoder block is configured to process a respective decoder block input to generate a respective decoder block output, wherein a spatial resolution of the decoder block output is greater than a spatial resolution of the decoder block input, and
for each decoder block that is after an initial decoder block in the sequence of decoder blocks, the decoder block input comprises: (i) an intermediate output of a respective encoder block, and (ii) a previous decoder block output of a previous decoder block.

Embodiment 20 is a system comprising: one or more computers and one or more storage devices storing instructions that are operable, when executed by the one or more computers, to cause the one or more computers to perform the method of any one of embodiments 1-19.

Embodiment 21 is one or more non-transitory computer storage media encoded with a computer program, the program comprising instructions that are operable, when executed by data processing apparatus, to cause the data processing apparatus to perform the method of any one of embodiments 1-19.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A method comprising:
obtaining an image of a manufactured article;
processing the image of the manufactured article using a defect detection neural network to generate a network output that predicts whether the manufactured article includes a defect, comprising:
processing the image of the manufactured article using an encoder subnetwork of the defect detection neural network to generate an encoder subnetwork output;
processing the encoder subnetwork output using a brain emulation subnetwork of the defect detection neural network to generate a brain emulation subnetwork output, wherein the brain emulation subnetwork has a brain emulation neural network architecture that comprises a plurality of brain emulation parameters that, when initialized, represent biological connectivity between a plurality of biological neuronal elements in a brain of a biological organism; and
processing the brain emulation subnetwork output using a decoder subnetwork of the defect detection neural network to generate the network output that predicts whether the manufactured article includes the defect; and
taking an action based on the network output that predicts whether the manufactured article includes the defect.

2. The method of claim 1, further comprising:
determining, from the network output, that the manufactured article includes the defect.

3. The method of claim 2, further comprising one or more of:
determining, from the network output, a type of defect that is included in the manufactured article; or
determining, from the network output, a portion of the manufactured article that includes the defect.

4. The method of claim 2, wherein taking the action based on the network output comprises:
in response to determining that the manufactured article includes the defect, providing one or more of (i) the manufactured article or (ii) the image of the manufactured article, for human inspection.

5. The method of claim 1, wherein the image of the manufactured article was captured by a camera directed at an assembly line carrying a plurality of manufactured articles.

6. The method of claim 1, wherein the network output comprises one or more of:
a classification of the manufactured article as either defective or not defective, or
a segmentation of the image of the manufactured article into a plurality of categories including at least one defect category.

7. The method of claim 6, wherein:
the network output comprises both the classification of the manufactured article and the segmentation of the image of the manufactured article, and
the method further comprises determining, from the network output, that the manufactured article includes the defect only if the classification of the manufactured article and the segmentation of the image of the manufactured article both indicate that the manufactured article includes the defect.

8. The method of claim 6, wherein the plurality of categories of the segmentation comprises a plurality of categories corresponding to respective possible types of defects.

9. The method of claim 1, wherein the defect detection neural network has been trained using a loss function that penalizes false-negative predictions more than false-positive predictions.

10. The method of claim 1, wherein the defect detection neural network is configured to process one or more different modalities of images of manufactured articles, the one or more modalities comprising one or more of: visible-light images, infrared images, x-ray images, ultraviolet images, multispectral images, hyperspectral images, or LIDAR images.

11. The method of claim 1, wherein the defect detection neural network has been trained using one or more auxiliary machine learning tasks that are different from predicting the presence of a defect in the manufactured article, the training comprising:
for each of the one or more auxiliary machine learning tasks:
processing a training image using the defect detection neural network to generate an auxiliary output for the auxiliary machine learning task, and
updating a set of network parameters of the defect detection neural network according to an error in the auxiliary output.

12. The method of claim 11, wherein the one or more auxiliary machine learning tasks comprise one or more of:
predicting a region of interest on the manufactured article,
predicting an orientation of the manufactured article,
predicting a color of the manufactured article, or
predicting a type of material included in the manufactured article.

13. The method of claim 1, wherein the plurality of brain emulation parameters represent biological connectivity between a strict subset of the plurality of biological neuronal elements in the brain of the biological organism, wherein each biological neuronal element in the strict subset processes visual sensory inputs in the brain of the biological organism.

14. The method of claim 1, wherein the plurality of brain emulation parameters representing synaptic connectivity between the plurality of biological neurons in the brain of the biological organism are arranged in a two-dimensional weight matrix having a plurality of rows and a plurality of columns,
wherein each row and each column of the weight matrix corresponds to a respective biological neuron from the plurality of biological neurons, and
wherein each brain emulation parameter in the weight matrix corresponds to a respective pair of biological neurons in the brain of the biological organism, the pair comprising: (i) the biological neuron corresponding to a row of the brain emulation parameter in the weight matrix, and (ii) the biological neuron corresponding to a column of the brain emulation parameter in the weight matrix.

15. The method of claim 14, wherein each brain emulation parameter of the weight matrix has a respective value that characterizes synaptic connectivity in the brain of the biological organism between the respective pair of biological neurons corresponding to the brain emulation parameter.

16. The method of claim 15, wherein each brain emulation parameter of the weight matrix that corresponds to a respective pair of biological neurons that are not connected by a synaptic connection in the brain of the biological organism has value zero.

17. The method of claim 15, wherein each brain emulation parameter of the weight matrix that corresponds to a respective pair of biological neurons that are connected by a synaptic connection in the brain of the biological organism has a respective non-zero value characterizing an estimated strength of the synaptic connection.

18. The method of claim 1, wherein:
the encoder subnetwork comprises a sequence of multiple encoder blocks, wherein:
each encoder block is configured to process a respective encoder block input to generate a respective encoder block output, wherein a spatial resolution of the encoder block output is lower than a spatial resolution of the encoder block input, and
for each encoder block that is after an initial encoder block in the sequence of encoder blocks, the encoder block input comprises a previous encoder block output of a previous encoder block in the sequence of encoder blocks; and
the decoder subnetwork comprises a sequence of multiple decoder blocks, wherein:
each decoder block is configured to process a respective decoder block input to generate a respective decoder block output, wherein a spatial resolution of the decoder block output is greater than a spatial resolution of the decoder block input, and
for each decoder block that is after an initial decoder block in the sequence of decoder blocks, the decoder block input comprises: (i) an intermediate output of a respective encoder block, and (ii) a previous decoder block output of a previous decoder block.

19. A system comprising one or more computers and one or more storage devices storing instructions that are operable, when executed by the one or more computers, to cause the one or more computers to perform operations comprising:
obtaining an image of a manufactured article;
processing the image of the manufactured article using a defect detection neural network to generate a network output that predicts whether the manufactured article includes a defect, comprising:
processing the image of the manufactured article using an encoder subnetwork of the defect detection neural network to generate an encoder subnetwork output;
processing the encoder subnetwork output using a brain emulation subnetwork of the defect detection neural network to generate a brain emulation subnetwork output, wherein the brain emulation subnetwork has a brain emulation neural network architecture that comprises a plurality of brain emulation parameters that, when initialized, represent biological connectivity between a plurality of biological neuronal elements in a brain of a biological organism; and
processing the brain emulation subnetwork output using a decoder subnetwork of the defect detection neural network to generate the network output that predicts whether the manufactured article includes the defect; and
taking an action based on the network output that predicts whether the manufactured article includes the defect.

20. One or more non-transitory computer storage media encoded with computer program instructions that when executed by a plurality of computers cause the plurality of computers to perform operations comprising:
obtaining an image of a manufactured article;
processing the image of the manufactured article using a defect detection neural network to generate a network output that predicts whether the manufactured article includes a defect, comprising:
processing the image of the manufactured article using an encoder subnetwork of the defect detection neural network to generate an encoder subnetwork output;
processing the encoder subnetwork output using a brain emulation subnetwork of the defect detection neural network to generate a brain emulation subnetwork output, wherein the brain emulation subnetwork has a brain emulation neural network architecture that comprises a plurality of brain emulation parameters that, when initialized, represent biological connectivity between a plurality of biological neuronal elements in a brain of a biological organism; and
processing the brain emulation subnetwork output using a decoder subnetwork of the defect detection neural network to generate the network output that predicts whether the manufactured article includes the defect; and
taking an action based on the network output that predicts whether the manufactured article includes the defect.
